(19) United States
(12) Patent Application Publication
(10) Pub. No.: US 2025/0264701 A1
(43) Pub. Date: Aug. 21, 2025

(54) OPTICAL SYSTEM, OPTICAL APPARATUS AND METHOD FOR MANUFACTURING THE OPTICAL SYSTEM

(71) Applicant: NIKON CORPORATION, Minato-ku, Tokyo (JP)

(72) Inventors: Tomoyuki SASHIMA, Tokyo (JP); Kosuke MACHIDA, Tokyo (JP)

(21) Appl. No.: 18/844,970

(22) PCT Filed: Mar. 3, 2023
(86) PCT No.: PCT/JP2023/008050

§ 371 Date: Sep. 8, 2024

(30) Foreign Application Priority Data
Mar. 17, 2022 (JP) 2022-043102

(51) Int. Cl. G02B 15/14

(52) U.S. Cl. CPC G02B 15/144107

(57) ABSTRACT

An optical system (OL) comprises a front group (GA), an intermediate group (GM), and a rear group (GR). The intermediate group (GM) comprises a first focusing lens group (GF1) and a second focusing lens group (GF2). During focusing, the first focusing lens group (GF1) and the second focusing lens group (GF2) move along the optical axis on different trajectories from each other. The front group (GA) and the rear group (GR) are fixed in relation to an image plane (I). The rear group (GR) has a negative lens disposed closest to the image plane. The following conditional formula is satisfied.

$$0.01 < fF 2 / fF 1 < 10. ;$$

$$0.5 < Y / Bf < 5. .$$

where,
fF1: the focal length of the first focusing lens group (GF1),
fF2: the focal length of the second focusing lens group (GF2),
Y: the image height of the optical system (OL),
Bf: the back focus of the optical system (OL).

### TECHNICAL FIELD

The present invention relates to an optical system, an optical apparatus, and a method for manufacturing the optical system.

### TECHNICAL BACKGROUND

In related art, an optical system suitable for a photographic camera, an electronic still camera, a video camera, or the like has been proposed (for example, see Patent Document 1). In such an optical system, it is difficult to obtain bright and favorable optical performance while achieving a small size.

### PRIOR ARTS LIST

### Patent Document

Patent Document 1: Japanese Laid-Open Patent Publication No. 2019-191502 (A)

### SUMMARY OF THE INVENTION

An optical system according to the present invention essentially consists of: a front group; an intermediate group; and a rear group, which are arranged in order from an object side along an optical axis, the intermediate group essentially consists of a first focusing lens group having positive refractive power and a second focusing lens group having positive refractive power, which are arranged in order from the object side along the optical axis, in focusing, the first focusing lens group and the second focusing lens group move along the optical axis differently with different loci from each other, and the front group and the rear group are fixed with respect to an image surface, the rear group comprises a negative lens which is arranged at a position closest to an image surface in the rear lens group, and the following conditional expressions are satisfied:

$$0.01 < fF 2 / fF 1 < 10.$$

$$0.5 < Y / Bf < 5. 00$$

where
   fF1: a focal length of the first focusing lens group,
   fF2: a focal length of the second focusing lens group,
   Y: an image height of the optical system, and
   Bf: a back focal length of the optical system.

An optical apparatus according to the present invention comprises the optical system.

A method for manufacturing an optical system according to the present invention, which essentially consists of: a front group; an intermediate group; and a rear group, which are arranged in order from an object side along an optical axis, comprising a step for arranging the lens groups in a lens barrel so that; the intermediate group essentially consists of a first focusing lens group having positive refractive power and a second focusing lens group having positive refractive power, which are arranged in order from the object along the optical axis, in focusing, the first focusing lens group and the second focusing lens group move along the optical axis differently with different loci from each other, and the front group and the rear group are fixed with respect to an image surface, the rear group comprises a negative lens which is arranged at a position closest to an image surface in the rear lens group, and the following conditional expressions are satisfied:

$$0.01 < fF 2 / fF 1 < 10.$$

$$0.5 < Y / Bf < 5. 00$$

where
   fF1: a focal length of the first focusing lens group,
   fF2: a focal length of the second focusing lens group,
   Y: an image height of the optical system, and
   Bf: a back focal length of the optical system.

### BRIEF DESCRIPTION OF THE DRAWINGS

FIG. 1 A diagram illustrating a lens configuration of an optical system according to a first example.

FIG. 2(A) and FIG. 2(B) respectively illustrate diagrams of various aberrations of the optical system according to the first example upon focusing on infinity and upon focusing on a short distance object.

FIG. 3 A diagram illustrating a lens configuration of an optical system according to a second example.

FIG. 4(A) and FIG. 4(B) respectively illustrate diagrams of various aberrations of the optical system according to the second example upon focusing on infinity and upon focusing on a short distance object.

FIG. 5 A diagram illustrating a lens configuration of an optical system according to a third example.

FIG. 6(A) and FIG. 6(B) respectively illustrate diagrams of various aberrations of the optical system according to the third example upon focusing on infinity and upon focusing on a short distance object.

FIG. 7 A diagram illustrating a lens configuration of an optical system according to a fourth example.

FIG. 8(A) and FIG. 8(B) respectively illustrate diagrams of various aberrations of the optical system according to the fourth example upon focusing on infinity and upon focusing on a short distance object.

FIG. 9 A diagram illustrating a lens configuration of an optical system according to a fifth example.

FIG. 10(A) and FIG. 10(B) respectively illustrate diagrams of various aberrations of the optical system according to the fifth example upon focusing on infinity and upon focusing on a short distance object.

FIG. 11 A diagram illustrating a lens configuration of an optical system according to a sixth example.

FIG. 12(A) and FIG. 12(B) respectively illustrate diagrams of various aberrations of the optical system according to the sixth example upon focusing on infinity and upon focusing on a short distance object.

FIG. 13 A diagram illustrating a lens configuration of an optical system according to a seventh example.

FIG. 14(A) and FIG. 14(B) respectively illustrate diagrams of various aberrations of the optical system according to the seventh example upon focusing on infinity and upon focusing on a short distance object.

FIG. 15 A diagram illustrating a lens configuration of an optical system according to an eighth example.

FIG. 16(A) and FIG. 16(B) respectively illustrate diagrams of various aberrations of the optical system according to the eighth example upon focusing on infinity and upon focusing on a short distance object.

FIG. 17 A diagram illustrating a configuration of a camera which includes the optical system according to the present embodiment.

FIG. 18 A flowchart illustrating a method for manufacturing the optical system according to the present embodiment.

### EMBODIMENTS FOR REALIZING THE INVENTIONS

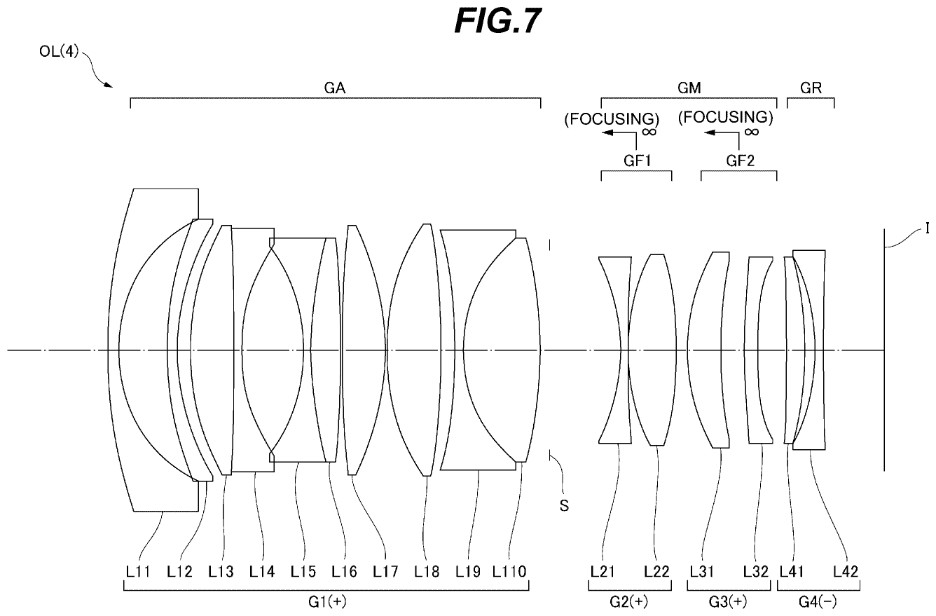

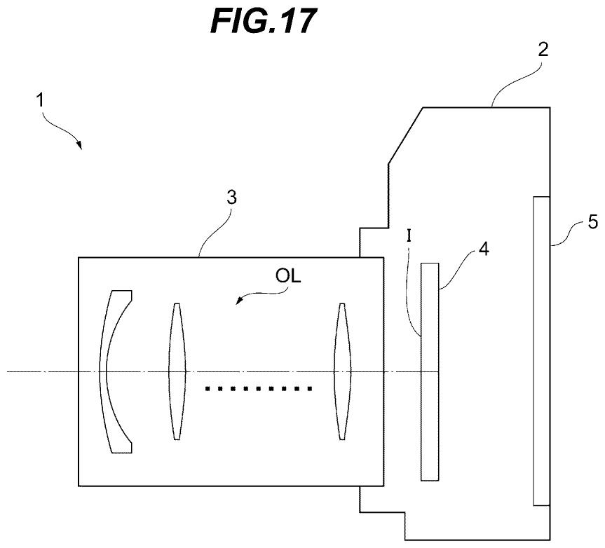

A preferable embodiment according to the present invention will hereinafter be described. First, a description will be made, based on FIG. 7, about a camera (optical apparatus) including an optical system according to the present embodiment. As illustrated in FIG. 17, this camera 1 is formed from a main body 2 and a photographing lens 3 to be mounted on the main body 2. The main body 2 includes an image-capturing element 4, a main-body control part (not illustrated) which controls actions of a digital camera, and a liquid crystal screen 5. The photographing lens 3 includes an optical system OL which is formed with plural lens groups and a lens position control mechanism (not illustrated) which controls a position of each of the lens groups. The lens position control mechanism is formed from a sensor which detects a position of the lens group, a motor which moves the lens group forward and rearward along an optical axis, a control circuit which drives a motor, and so forth.

Light from a photographed object is collected by the optical system OL of the photographing lens 3 and reaches an image surface I of the image-capturing element 4. Light from the photographed object which reaches the image surface I is subjected to photoelectric conversion by the image-capturing element 4 and is recorded as digital image data in a memory which is not illustrated. The digital image data recorded in the memory can be displayed on the liquid crystal screen 5 in response to an operation by a user. Note that this camera may be a mirrorless camera or a single-lens reflex camera having an instant return mirror. Further, the optical system OL illustrated in FIG. 17 schematically illustrates the optical system which is included in the photographing lens 3, and a lens configuration of the optical system OL is not limited to this configuration.

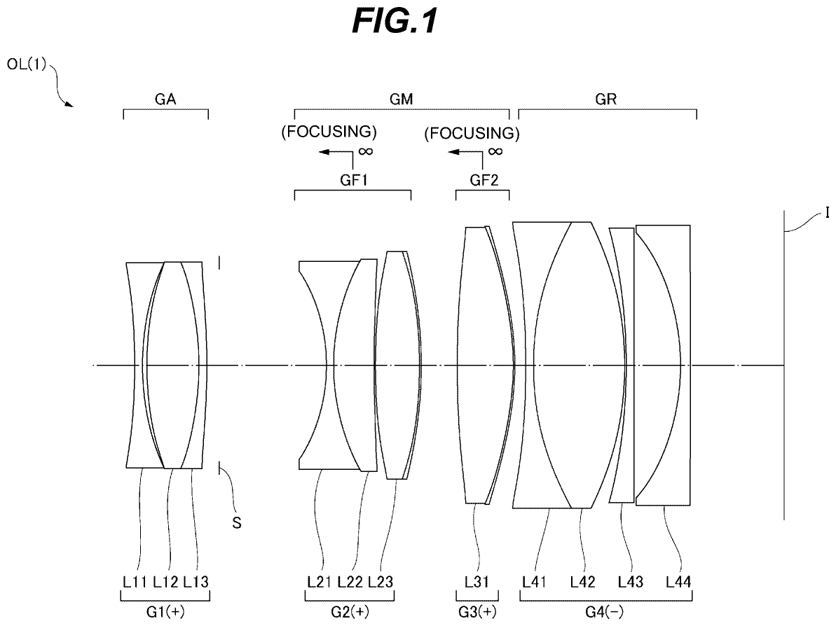

Next, the optical system according to the present embodiment will be described. As illustrated in FIG. 1, an optical system OL(1) as one example of the optical system OL according to the present embodiment is formed from a front group GA, an intermediate group GM, and a rear group GR, which are arranged in order from an object side along the optical axis. The intermediate group GM consists of a first focusing lens group GF1 having positive refractive power and a second focusing lens group GF2 having positive refractive power, which are arranged in order from the object side along the optical axis. In focusing, the first focusing lens group GF1 and the second focusing lens group GF2 move along the optical axis differently with different loci from each other. The front group GA and the rear group GR are fixed with respect to the image surface I. The rear group GR has a negative lens (L44) which is arranged at a position closest to an image surface in the rear group GR.

In the above configuration, the optical system OL according to the present embodiment satisfies the following conditional expression (1) and conditional expression (2).

$$0.01 < fF 2 / fF 1 < 10. \qquad ( 1 )$$

$$0.5 < Y / Bf < 5. \qquad ( 2 )$$

where
fF1: a focal length of the first focusing lens group GF1,
fF2: a focal length of the second focusing lens group GF2,
Y: an image height of the optical system OL, and
Bf: a back focal length of the optical system OL.

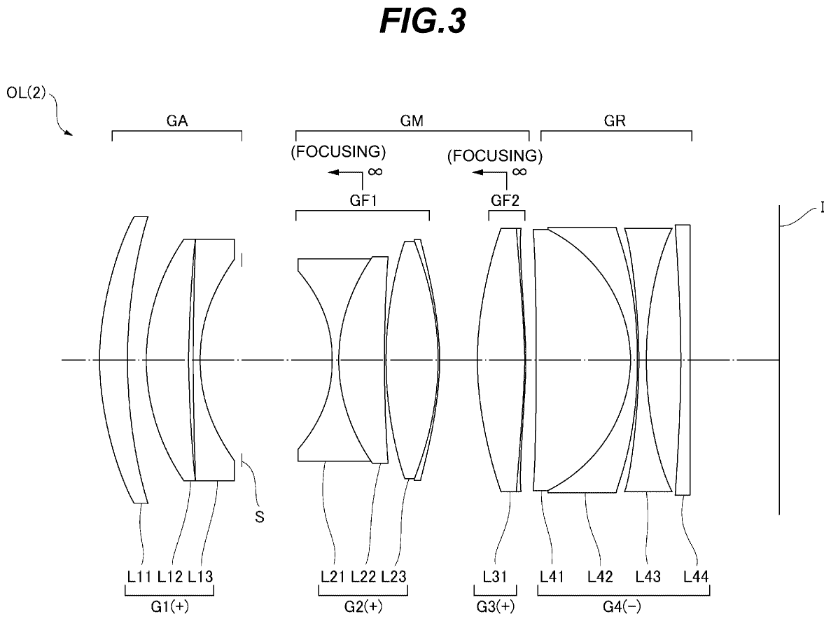

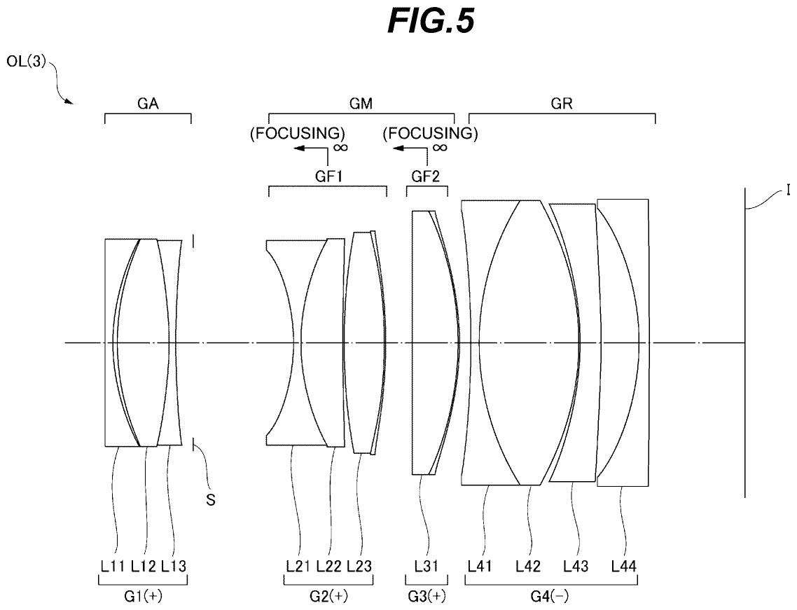

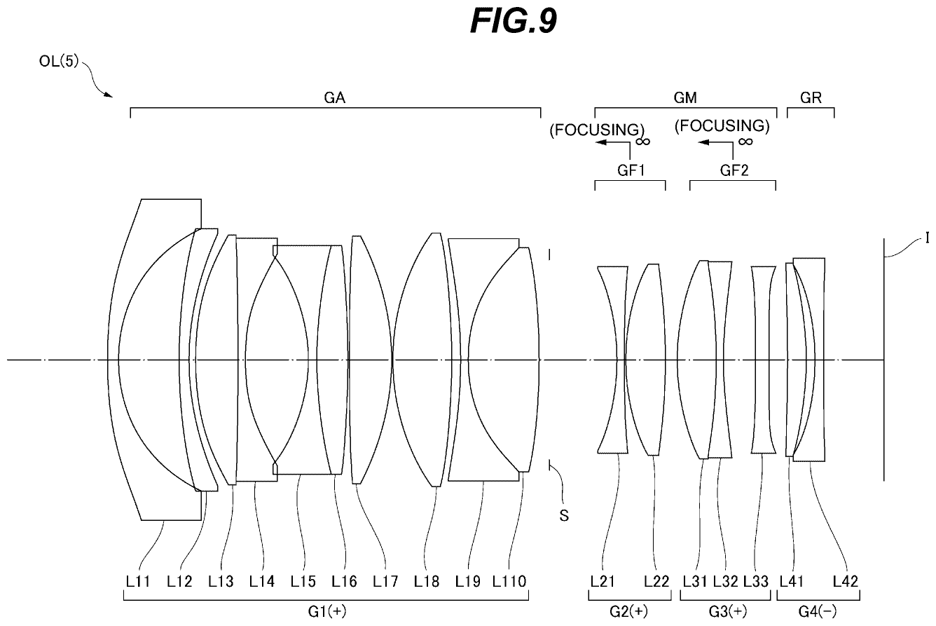

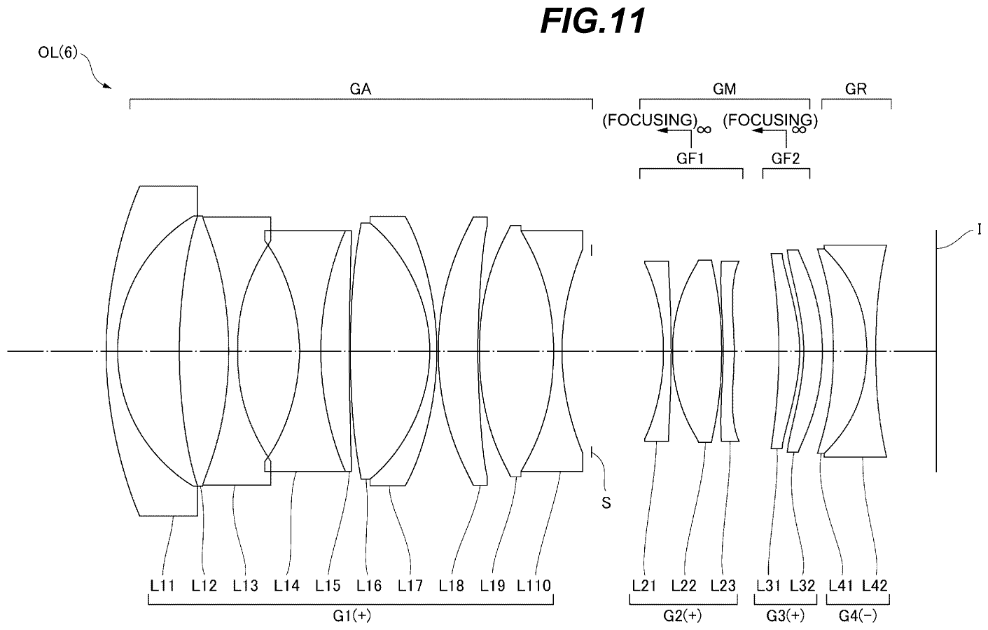

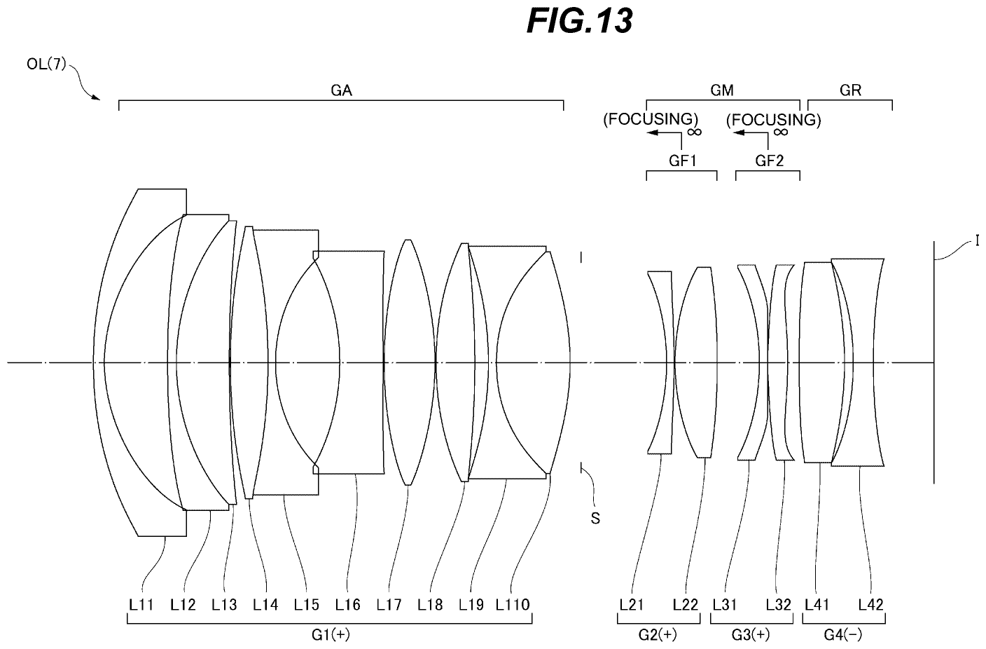

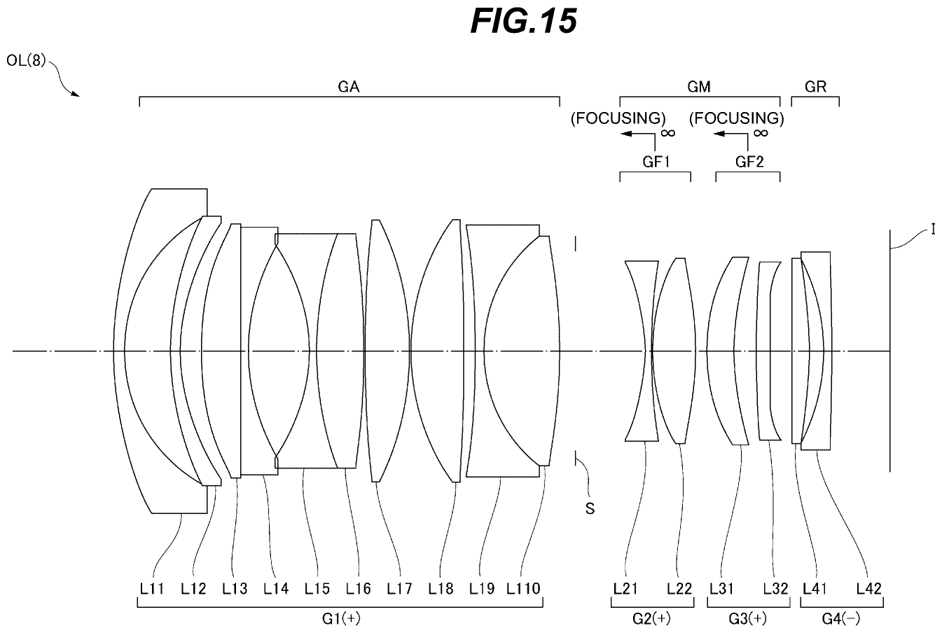

In the present embodiment, it becomes possible to obtain an optical system having bright and favorable optical performance while having a small size and an optical apparatus including the optical system. The optical system OL according to the present embodiment may be an optical system OL(2) illustrated in FIG. 3, may be an optical system OL(3) illustrated in FIG. 5, or may be an optical system OL(4) illustrated in FIG. 7. Further, the optical system OL according to the present embodiment may be an optical system OL(5) illustrated in FIG. 9, may be an optical system OL(6) illustrated in FIG. 11, may be an optical system OL(7) illustrated in FIG. 13, or may be an optical system OL(8) illustrated in FIG. 15.

The conditional expression (1) defines an appropriate relationship between the focal length of the second focusing lens group GF2 and the focal length of the first focusing lens group GF1. By satisfying the conditional expression (1), various aberrations such as a coma aberration can properly be corrected.

Because when a corresponding value of the conditional expression (1) exceeds an upper limit value, the refractive power of the first focusing lens group GF1 becomes too strong, it becomes difficult to correct a spherical aberration and the coma aberration in focusing on a short distance object. The upper limit value of the conditional expression (1) is set to 8.50, 7.50, 7.00, 5.00, 4.00, 3.50, 2.50, 2.00, or further 1.50, and effects of the present embodiment can thereby more certainly be obtained.

Because when the corresponding value of the conditional expression (1) becomes below a lower limit value, the refractive power of the second focusing lens group GF2 becomes too strong, it becomes difficult to correct the coma aberration and a curvature of field in focusing on a short distance object. The lower limit value of the conditional expression (1) is set to 0.05 or further 0.09, and the effects of the present embodiment can thereby more certainly be obtained.

The conditional expression (2) defines an appropriate relationship between the image height of the optical system OL and the back focal length of the optical system OL. Note that in the present embodiment, the back focal length of the optical system OL is set as an air equivalent distance, on an optical axis, from a lens surface, which is closest to the image surface, of the optical system OL to the image surface I. By satisfying the conditional expression (2), it becomes possible to obtain an optical system having bright and favorable optical performance while having a small size. The upper limit value of the conditional expression (2) is set to 4.50, 4.00, 3.50, 3.00, 2.50, or further 2.00, and the effects of the present embodiment can thereby more certainly be obtained. Further, the lower limit value of the conditional expression (2) is set to 1.00 or further 1.40, and the effects of the present embodiment can thereby more certainly be obtained.

It is desirable that the optical system OL according to the present embodiment further have an aperture stop S and satisfy the following conditional expression (3).

$$0. 05 < fSr / fSa < 4 \text{.00} \qquad ( 3 )$$

where
fSr: a combined focal length, upon focusing on infinity, of a lens, which is arranged on the image surface side relative to the aperture stop S, in the optical system OL, and
fSa: the combined focal length, upon focusing on infinity, of a lens, which is arranged on the object side relative to the aperture stop S, in the optical system OL.

The conditional expression (3) defines an appropriate relationship between the combined focal length, upon focusing on infinity, of the lens, which is arranged on the image surface side relative to the aperture stop S, in the optical system OL and the combined focal length, upon focusing on infinity, of the lens, which is arranged on the object side relative to the aperture stop S, in the optical system OL. By satisfying the conditional expression (3), the spherical aberration, the coma aberration, and the curvature of field can properly be corrected.

Because when the corresponding value of the conditional expression (3) exceeds the upper limit value, refractive power of the lens, which is arranged on the object side relative to the aperture stop S, in the optical system OL becomes too strong, it becomes difficult to correct the spherical aberration, the coma aberration, and the curvature of field. The upper limit value of the conditional expression (3) is set to 3.50, 3.00, 2.50, or further 2.30, and the effects of the present embodiment can thereby more certainly be obtained.

Because when the corresponding value of the conditional expression (3) becomes below the lower limit value, refractive power of the lens, which is arranged on the image surface side relative to the aperture stop S, in the optical system OL becomes too strong, it becomes difficult to correct the spherical aberration, the coma aberration, and the curvature of field. The lower limit value of the conditional expression (3) is set to 0.13 or further 0.18, and the effects of the present embodiment can thereby more certainly be obtained.

It is desirable that the optical system OL according to the present embodiment satisfy the following conditional expression (4).

$$0. 05 < fF 2 / fA < 8 \text{.00} \qquad ( 4 )$$

where fA: the focal length of the front group GA.

The conditional expression (4) defines an appropriate relationship between the focal length of the second focusing lens group GF2 and the focal length of the front group GA. By satisfying the conditional expression (4), various aberrations such as the coma aberration and the curvature of field can properly be corrected.

Because when the corresponding value of the conditional expression (4) exceeds the upper limit value, refractive power of the front group GA becomes too strong, it becomes difficult to correct the spherical aberration, the coma aberration, and the curvature of field. The upper limit value of the conditional expression (4) is set to 6.00, 5.00, 4.00, 3.00, 2.00, or further 1.50, and the effects of the present embodiment can thereby more certainly be obtained.

Because when the corresponding value of the conditional expression (4) becomes below the lower limit value, the refractive power of the second focusing lens group GF2 becomes too strong, it becomes difficult to correct the coma aberration and a curvature of field in focusing on a short distance object. The lower limit value of the conditional expression (4) is set to 0.10 or further 0.20, and the effects of the present embodiment can thereby more certainly be obtained.

It is desirable that the optical system OL according to the present embodiment satisfy the following conditional expression (5).

$$0.1 < - fR / fF 2 < 8. \qquad ( 5 )$$

where fR: the focal length of the rear group GR.

The conditional expression (5) defines an appropriate relationship between the focal length of the rear group GR and the focal length of the second focusing lens group GF2. By satisfying the conditional expression (5), the coma aberration and the curvature of field can properly be corrected.

Because when the corresponding value of the conditional expression (5) exceeds the upper limit value, the refractive power of the second focusing lens group GF2 becomes too strong, it becomes difficult to correct the coma aberration and the curvature of field in focusing on a short distance object. The upper limit value of the conditional expression (5) is set to 6.00, 5.00, 4.00, 3.00, or further 2.50, and the effects of the present embodiment can thereby more certainly be obtained.

Because when the corresponding value of the conditional expression (5) becomes below the lower limit value, refractive power of the rear group GR becomes too strong, it becomes difficult to correct the coma aberration and the curvature of field. The lower limit value of the conditional expression (5) is set to 0.30 or further 0.60, and the effects of the present embodiment can thereby more certainly be obtained.

It is desirable that the optical system OL according to the present embodiment satisfy the following conditional expression (6).

$$0. 02 < fA / fF 1 < 4. \qquad ( 6 )$$

where fA: the focal length of the front group GA.

The conditional expression (6) defines an appropriate relationship between the focal length of the front group GA and the focal length of the first focusing lens group GF1. By satisfying the conditional expression (6), various aberrations such as the spherical aberration and the coma aberration can properly be corrected.

Because when the corresponding value of the conditional expression (6) exceeds the upper limit value, the refractive power of the first focusing lens group GF1 becomes too strong, it becomes difficult to correct the spherical aberration and the coma aberration in focusing on a short distance object. The upper limit value of the conditional expression (6) is set to 3.50, 3.00, 2.50, or further 2.00, and the effects of the present embodiment can thereby more certainly be obtained.

Because when the corresponding value of the conditional expression (6) becomes below the lower limit value, the refractive power of the front group GA becomes too strong, it becomes difficult to correct the spherical aberration, the coma aberration, and the curvature of field. The lower limit value of the conditional expression (6) is set to 0.05 or further 0.08, and the effects of the present embodiment can thereby more certainly be obtained.

It is desirable that the optical system OL according to the present embodiment satisfy the following conditional expression (7).

$$0. 10 < fF 1 / ( - fR ) < 8 \text{.00} \qquad ( 7 )$$

where fR: the focal length of the rear group GR.

The conditional expression (7) defines an appropriate relationship between the focal length of the first focusing lens group GF1 and the focal length of the rear group GR. By satisfying the conditional expression (7), various aberrations such as the coma aberration can properly be corrected.

Because when the corresponding value of the conditional expression (7) exceeds the upper limit value, the refractive power of the rear group GR becomes too strong, it becomes difficult to correct the coma aberration and the curvature of field. The upper limit value of the conditional expression (7) is set to 6.00 or further 5.00, and the effects of the present embodiment can thereby more certainly be obtained.

Because when the corresponding value of the conditional expression (7) becomes below the lower limit value, the refractive power of the first focusing lens group GF1 becomes too strong, it becomes difficult to correct the spherical aberration and the coma aberration in focusing on a short distance object. The lower limit value of the conditional expression (7) is set to 0.20 or further 0.30, and the effects of the present embodiment can thereby more certainly be obtained.

It is desirable that the optical system OL according to the present embodiment satisfy the following conditional expression (8).

$$0.1 < fA / ( - fR ) < 4 \text{.00} \qquad ( 8 )$$

where fR: the focal length of the rear group GR.

The conditional expression (8) defines an appropriate relationship between the focal length of the front group GA and the focal length of the rear group GR. By satisfying the conditional expression (8), various aberrations such as the coma aberration and the curvature of field can properly be corrected.

Because when the corresponding value of the conditional expression (8) exceeds the upper limit value, the refractive power of the rear group GR becomes too strong, it becomes difficult to correct the coma aberration and the curvature of field. The upper limit value of the conditional expression (8) is set to 3.00 or further 2.50, and the effects of the present embodiment can thereby more certainly be obtained.

Because when the corresponding value of the conditional expression (8) becomes below the lower limit value, the refractive power of the front group GA becomes too strong, it becomes difficult to correct the spherical aberration, the coma aberration, and the curvature of field. The lower limit value of the conditional expression (8) is set to 0.20 or further 0.30, and the effects of the present embodiment can thereby more certainly be obtained.

It is desirable that the optical system OL according to the present embodiment satisfy the following conditional expression (9).

$$1. 00 < f / Bf < 8 \text{.00} \qquad ( 9 )$$

where f: the focal length of the optical system OL.

The conditional expression (9) defines an appropriate relationship between the focal length of the optical system OL and the back focal length of the optical system OL. By satisfying the conditional expression (9), it becomes possible to obtain an optical system having bright and favorable optical performance while having a small size. The upper limit value of the conditional expression (9) is set to 6.00 or further 4.50, and the effects of the present embodiment can thereby more certainly be obtained. Further, the lower limit value of the conditional expression (9) is set to 1.50 or further 2.50, and the effects of the present embodiment can thereby more certainly be obtained.

It is desirable that the optical system OL according to the present embodiment satisfy the following conditional expression (10).

$$0. 50 < TL / f < 7 \text{.00} \qquad ( 10 )$$

where
f: the focal length of the optical system OL, and
TL: an entire length of the optical system OL.

The conditional expression (10) defines an appropriate relationship between the entire length of the optical system OL and the focal length of the optical system OL. Note that in the present embodiment, the entire length of the optical system OL is set as the distance, on the optical axis, from the lens surface of the optical system OL, which is closest to the object, to the image surface I (where the distance, on the optical axis, from the lens surface of the optical system OL, which is closest to the image surface, to the image surface I is the air equivalent distance). By satisfying the conditional expression (10), it becomes possible to obtain an optical system having bright and favorable optical performance while having a small size. The upper limit value of the conditional expression (10) is set to 6.00 or further 5.00, and the effects of the present embodiment can thereby more certainly be obtained. Further, the lower limit value of the conditional expression (10) is set to 1.00 or further 1.50, and the effects of the present embodiment can thereby more certainly be obtained.

It is desirable that the optical system OL according to the present embodiment satisfy the following conditional expression (11).

$$0.1 < fe / - fR < 0 \text{.90} \qquad ( 11 )$$

where
fe: the focal length of a negative lens which is arranged in a position of the rear group GR which is closest to the image surface, and
fR: the focal length of the rear group GR.

The conditional expression (11) defines an appropriate relationship between the focal length of the negative lens, which is arranged on the position of the rear group GR which is closest to the image surface, and the focal length of the rear group GR. By satisfying the conditional expression (11), various aberrations such as the curvature of field can properly be corrected.

Because when the corresponding value of the conditional expression (11) exceeds the upper limit value, the refractive power of the rear group GR becomes too strong, it becomes difficult to correct the coma aberration and the curvature of field. The upper limit value of the conditional expression (11) is set to 0.85 or further 0.75, and the effects of the present embodiment can thereby more certainly be obtained.

Because when the corresponding value of the conditional expression (11) becomes below the lower limit value, refractive power of the negative lens, which is arranged on the position of the rear group GR which is closest to the image surface, becomes too strong, it becomes difficult to correct the curvature of field. The lower limit value of the conditional expression (11) is set to 0.15 or further 0.20, and the effects of the present embodiment can thereby more certainly be obtained.

It is desirable that the optical system OL according to the present embodiment further have the aperture stop S which is arranged between the front group GA and the intermediate group GM. Accordingly, it becomes possible to correct the spherical aberration, the coma aberration, and the curvature of field in focusing on a short distance object.

In the optical system OL according to the present embodiment, it is desirable that the front group GA have positive refractive power. Accordingly, it becomes possible to correct the spherical aberration, the coma aberration, and the curvature of field.

In the optical system OL according to the present embodiment, it is desirable that the rear group GR have negative refractive power. Accordingly, it becomes possible to correct the coma aberration and the curvature of field.

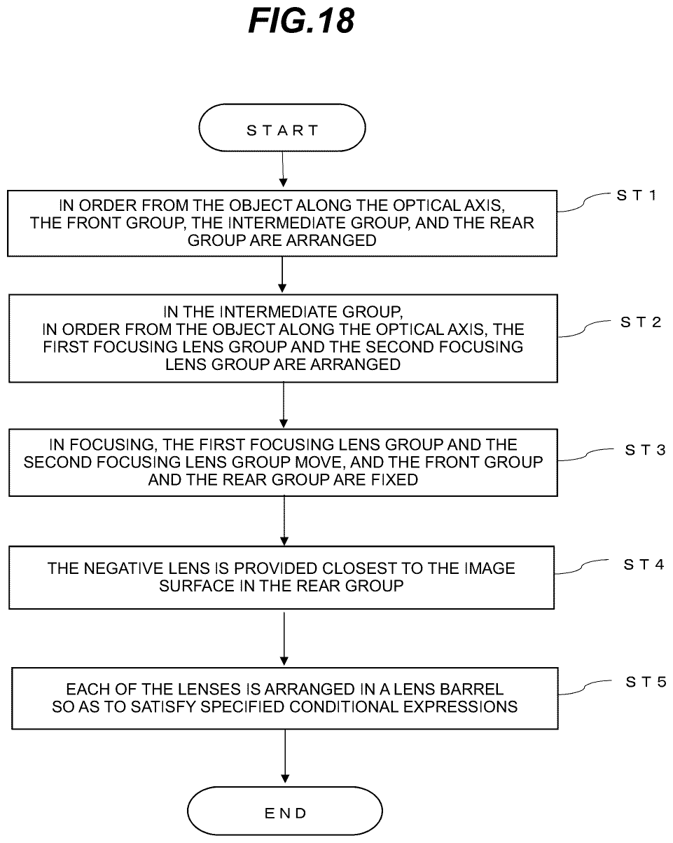

Next, a method for manufacturing the optical system OL according to the present embodiment will be outlined with reference to FIG. 18. First, in order from the object side along the optical axis, the front group GA, the intermediate group GM, and the rear group GR are arranged (step ST1). Next, in the intermediate group GM, in order from the object side along the optical axis, the first focusing lens group GF1 having the positive refractive power and the second focusing lens group GF2 having the positive refractive power are arranged (step ST2). Next, a configuration is made such that in focusing, the first focusing lens group GF1 and the second focusing lens group GF2 move along the optical axis differently with different loci from each other. The front group GA and the rear group GR are fixed with respect to the image surface I (step ST3). Further, the negative lens is provided closest to the image surface in the rear group GR (step ST4). Furthermore, each of the lenses is arranged in a lens barrel such that at least the above conditional expression (1) and conditional expression (2) are satisfied (step ST5). In such a method for manufacturing the optical system, it becomes possible to manufacture an optical system having bright and favorable optical performance while having a small size.

### EXAMPLES

In the following, the optical systems OL according to examples of the present embodiment will be described based on the drawings. FIG. 1, FIG. 3, FIG. 5, FIG. 7, FIG. 9, FIG. 11, FIG. 13, and FIG. 15 are cross-sectional diagrams which respectively illustrate configurations and refractive power distribution of the optical systems OL {OL(1) to OL(8)} according to first to eighth examples. In the cross-sectional diagrams of the optical systems OL(1) to OL(8) according to the first to eighth examples, a movement direction of each of the lens groups along the optical axis in focusing from infinity to a short distance object is indicated by an arrow.

In FIG. 1, FIG. 3, FIG. 5, FIG. 7, FIG. 9, FIG. 11, FIG. 13, and FIG. 15, each of the lens groups is denoted by a combination of a reference character G and a numeral, and each of the lenses is denoted by a combination of a reference character L and a numeral. In this case, in order to prevent a situation where kinds and the numbers of reference characters and numerals are increased and cause complication, lens groups and so forth are denoted by using independent combinations of reference characters and numerals for each of the examples. Thus, even when the same combinations of reference characters and numerals are used among the examples, this does not mean the same configuration.

Although table 1 to table 8 are illustrated in the following, among those, the table 1, the table 2, the table 3, the table 4, the table 5, the table 6, the table 7, and the table 8 are tables which represent respective data of the first example, the second example, the third example, the fourth example, the fifth example, the sixth example, the seventh example, and the eighth example. In each of the examples, as targets of calculation of aberration characteristics, a d-line (wavelength λ=587.6 nm) and a g-line (wavelength λ=435.8 nm) are selected.

In a table of [general data], f denotes a focal length of a whole lens system, FNO denotes an F-number, and ω denotes half angle of view (its unit is “°” (degree)), and Y denotes an image height. A reference character TL denotes a distance in which Bf (back focal length) is added to a distance, on the optical axis, from a lens surface of the optical system, which is closest to the object, to a lens surface, which is closest to the image surface side, upon focusing on infinity, and Bf denotes a distance (air equivalent distance), on the optical axis, from the lens surface of the optical system, which is closest to the image surface, to an image surface upon focusing on infinity.

Further, in the table of [general data], fA demotes the focal length of a front group. A reference character fR denotes the focal length of a rear group. A reference character fF1 denotes the focal length of a first focusing lens group. A reference character fF2 denotes the focal length of a second focusing lens group. A reference character fSa denotes the combined focal length, upon focusing on infinity, of a lens, which is arranged on the object side relative to an aperture stop, in the optical system. A reference character fSr denotes the combined focal length, upon focusing on infinity, of a lens, which is arranged on the image surface side relative to the aperture stop, in the optical system. A reference character fe denotes the focal length of a negative lens which is arranged in a position of the rear group which is closest to the image surface.

In a table of [lens data], a surface number denotes order of optical surfaces from the object side along a direction in which a beam of light progresses, R denotes a radius of curvature of each of the optical surfaces (a positive value is given to a surface whose center of curvature is positioned on the image side), D denotes a surface distance as a distance on the optical axis from each of the optical surfaces to the next optical surface (or the image surface), nd denotes a refractive index of a material of an optical member with respect to the d-line, and vd denotes the Abbe number of the material of the optical member with respect to the d-line as a reference. A radius of curvature of “∞” denotes a flat surface or an opening, and (aperture stop S) denotes the aperture stop S. A refractive index nd of air=1.00000 is not indicated. In a case where the optical surface is an aspherical surface, “*” sign is given to the surface number, and a paraxial radius of curvature is indicated in a field of the radius of curvature R.

In a table of [aspherical surface data], a shape of an aspherical surface indicated in [lens data] is expressed by the following expression (A). A term X(y) represents a distance (sag quantity), along an optical axis direction, from a tangential plane at an apex of the aspherical surface to a position on the aspherical surface at a height y, R denotes a radius of curvature (paraxial radius of curvature) of a reference spherical surface, κ denotes a conic constant, and Ai denotes an aspherical coefficient at the i-th order. A term “E-n” denotes “×10-n”. For example, 1.234E-05=1.234×10-5. Note that an aspherical coefficient A2 at the second order is zero and is not indicated.

$$X ( y ) = ( {y}^{2} / R ) / \{ 1 + {( 1 - κ \times {y}^{2} / {R}^{2} )}^{1 / 2} \} + A 4 \times {y}^{4} + A 6 \times {y}^{6} + A 8 \times {y}^{8} + A 10 \times {y}^{10} \qquad ( A )$$

A table of [variable distance data] indicates each surface distance at a surface number i for which the surface distance is (Di) in the table of [lens data]. Further, the table of [variable distance data] indicates each surface distance upon focusing on infinity and each surface distance upon focusing on a short distance object. In the table of [variable distance data], f denotes the focal length of the whole lens system, and β denotes a photographing magnification. Further, D0 denotes a distance from an object to an optical surface in the optical system, which is closest to the object.

A table of [lens group data] indicates a first surface (a surface closest to the object) and a focal length of each of the lens groups.

In the following, in all of data values, “mm” is in general used for the focal lengths f, the radii of curvature R, the surface distances D, other lengths, and so forth, which appear herein, unless otherwise mentioned; however, this is not restrictive because the optical system can obtain equivalent optical performance even when the optical system is proportionally enlarged or proportionally shrunk.

The above descriptions about the tables are common to all of the examples, and the descriptions will not be repeated in the following.

### First Example

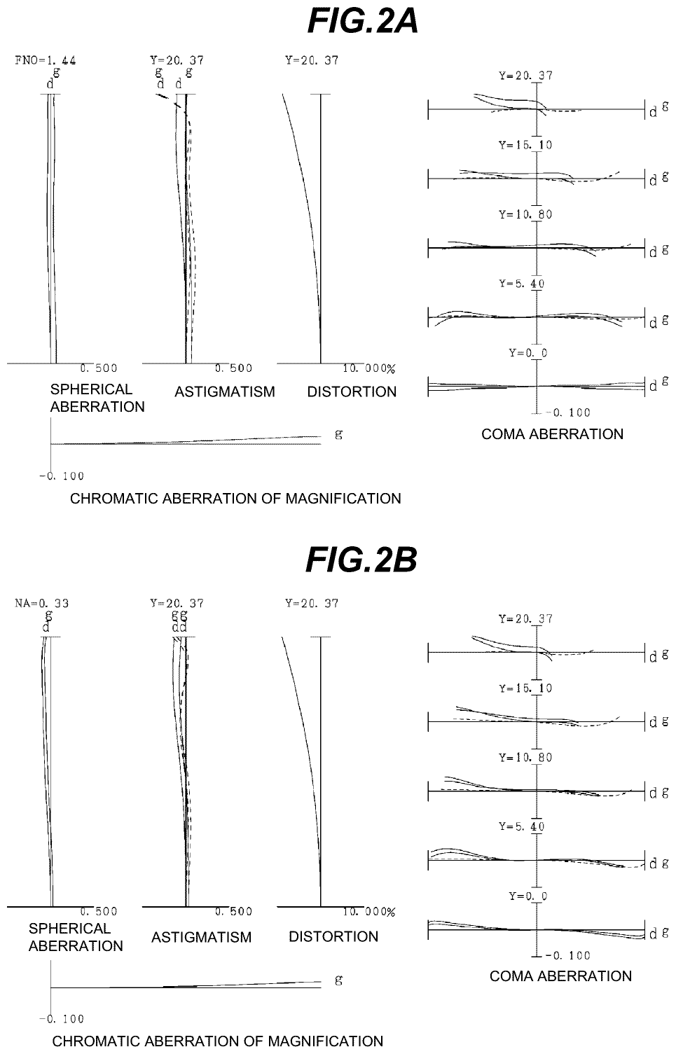

The first example will be described by using FIG. 1, FIG. 2, and the table 1. FIG. 1 is a diagram illustrating a lens configuration of the optical system according to the first example. The optical system OL(1) according to the first example is formed from a first lens group G1 having positive refractive power, a second lens group G2 having positive refractive power, a third lens group G3 having positive refractive power, and a fourth lens group G4 having negative refractive power, which are arranged in order from the object side along the optical axis. In focusing from an object at infinity to an object at a short distance, the second lens group G2 and the third lens group G3 move to the object side along the optical axis in different loci (different in movement amounts), and intervals between the neighboring lens groups are thereby changed. Note that in focusing, positions of the first lens group G1 and the fourth lens group G4 are fixed with respect to the image surface I. A reference character (+) or (−) given to each lens group character indicates refractive power of each lens group, and the same applies to all of the following examples.

The aperture stop S is disposed between the first lens group G1 and the second lens group G2. In focusing, a position of the aperture stop S is fixed with respect to the image surface I. In the present example, the first lens group G1 constitutes the front group GA, the second lens group G2 and the third lens group G3 constitute the intermediate group GM, and the fourth lens group G4 constitutes the rear group GR. Further, the second lens group G2 corresponds to the first focusing lens group GF1, and the third lens group G3 corresponds to the second focusing lens group GF2.

The first lens group G1 is formed from a biconcave negative lens L11 and a cemented positive lens in which a biconvex positive lens L12 and a negative meniscus lens L13 having a concave surface facing the object side are joined together, and the above lenses are arranged in order from the object side along the optical axis.

The second lens group G2 is formed from a cemented negative lens, in which a biconcave negative lens L21 and a positive meniscus lens L22 having a convex surface facing the object side are joined together, and a biconvex positive lens L23, and the above lenses are arranged in order from the object side along the optical axis. The positive lens L23 is a hybrid type lens which is configured such that a resin layer is provided on a surface of a glass-made lens main body on an image surface side. The surface of the resin layer on the image surface side is an aspherical surface, and the positive lens L23 is a composite type aspherical lens. In [lens data] which will be described later, a surface number 10 denotes a surface of the lens main body on the object side, a surface number 11 denotes a surface of the lens main body on the image surface side and a surface of the resin layer on the object side (the surface on which both of those are joined together), and a surface number 12 denotes a surface of the resin layer on the image surface side.

The third lens group G3 is formed from a biconvex positive lens L31. The positive lens L31 is a hybrid type lens which is configured such that a resin layer is provided on a surface of a glass-made lens main body on the image surface side. The surface of the resin layer on the image surface side is an aspherical surface, and the positive lens L31 is a composite type aspherical lens. In [lens data] which will be described later, a surface number 13 denotes a surface of the lens main body on the object side, a surface number 14 denotes a surface of the lens main body on the image surface side and a surface of the resin layer on the object side (the surface on which both of those are joined together), and a surface number 15 denotes a surface of the resin layer on the image surface side.

The fourth lens group G4 is formed from a cemented positive lens in which a biconcave negative lens L41 and a biconvex positive lens L42 are joined together, a biconcave negative lens L43, and a plano-concave negative lens L44 having a flat surface facing the image surface side, and the above lenses are arranged in order from the object side along the optical axis. The image surface I is arranged on the image side of the fourth lens group G4.

The following table 1 raises values of data of the optical system according to the first example.

TABLE 1
[General Data]

| | |
|---|---|
| f = 36.050 | FNO = 1.442 |
| ω = 31.814 | Y = 20.374 |
| TL = 83.685 | Bf = 12.113 |
| FA = 154.383 | fR = −70.566 |
| fF1 = 150.000 | fF2 = 42.786 |
| fSa = 154.383 | fSr = 41.385 |
| fe = −49.090 | |

[Lens Data]

| Surface | | | | |
|---|---|---|---|---|
| Number | R | D | nd | νd |
| 1 | −84.278 | 1.000 | 1.48749 | 70.31 |
| 2 | 34.272 | 0.582 | | |
| 3 | 42.331 | 6.737 | 1.83481 | 42.73 |
| 4 | −39.159 | 0.900 | 1.76182 | 26.58 |
| 5 | −167.335 | 1.600 | | |
| 6 | ∞ | (D6) | | (Aperture |
| | | | | Stop S) |
| 7 | −23.995 | 0.900 | 1.64769 | 33.73 |
| 8 | 28.408 | 5.263 | 1.83481 | 42.73 |
| 9 | 214.240 | 0.100 | | |
| 10 | 69.377 | 5.846 | 1.83481 | 42.73 |
| 11 | −52.510 | 0.100 | 1.56093 | 36.64 |
| 12* | −50.272 | (D12) | | |
| 13 | 133.009 | 7.274 | 1.77250 | 49.62 |
| 14 | −47.184 | 0.100 | 1.56093 | 36.64 |
| 15* | −41.494 | (D15) | | |
| 16 | −101.299 | 1.000 | 1.68893 | 31.16 |
| 17 | 37.985 | 11.824 | 1.83481 | 42.73 |
| 18 | −43.191 | 0.100 | | |
| 19 | −79.644 | 1.000 | 1.78472 | 25.64 |
| 20 | 863.090 | 6.024 | | |
| 21 | −30.438 | 1.300 | 1.62004 | 36.40 |
| 22 | ∞ | Bf | | |

[Aspherical Surface Data]
12th Surface
κ = 1.0000, A4 = 9.82707E−06, A6 = 8.10431E−09,
A8 = −4.53816E−11, A10 = 8.08855E−14
15th Surface
κ = 1.0000, A4 = 7.20448E−06, A6 = 3.36893E−10,
A8 = 3.34430E−11, A10 = −3.62441E−14

[Variable Distance Data]

| | Upon focusing | Upon focusing on a |
|---|---|---|
| | on infinity | short-distance object |
| | f = 36.050 | β = −0.03333 |
| D0 | ∞ | 1073.885 |
| D6 | 13.904 | 12.690 |
| D12 | 4.519 | 4.847 |
| D15 | 1.500 | 2.386 |
| Bf | 12.113 | 12.113 |

[Lens Group Data]

| Group | First surface | Focal length |
|---|---|---|
| G1 | 1 | 154.383 |
| G2 | 7 | 150.000 |
| G3 | 13 | 42.786 |
| G4 | 16 | −70.566 |

FIG. 2(A) illustrates diagrams of various aberrations of the optical system according to the first example upon focusing on infinity. FIG. 2(B) illustrates diagrams of various aberrations of the optical system according to the first example upon focusing on a short distance object. In each of the diagrams of aberrations upon focusing on infinity, FNO denotes an F-number, and Y denotes an image height. In each of the diagrams of aberrations upon focusing on a short distance object, NA denotes a numerical aperture, and Y denotes the image height. Note that a spherical aberration diagram indicates the value of the F-number or the numerical aperture which corresponds to the maximum aperture, an astigmatism diagram and a distortion diagram respectively indicate the maximum values of the image height, and a coma aberration diagram indicates the value of each image height. A reference character d denotes the d-line (wavelength λ=587.6 nm), and g denotes the g-line (wavelength λ=435.8 nm). In the astigmatism diagram, a solid line indicates a sagittal image surface, and a broken line indicates a meridional image surface. Note that also in diagrams of aberrations in each of the examples, which will be described in the following, similar reference characters to the present example will be used, and descriptions thereof will not be repeated.

Based on each of the diagrams of various aberrations, it may be understood that not only upon focusing on infinity but also focusing on a short distance object, the optical system according to the first example properly corrects various aberrations and exhibits excellent image formation performance.

### Second Example

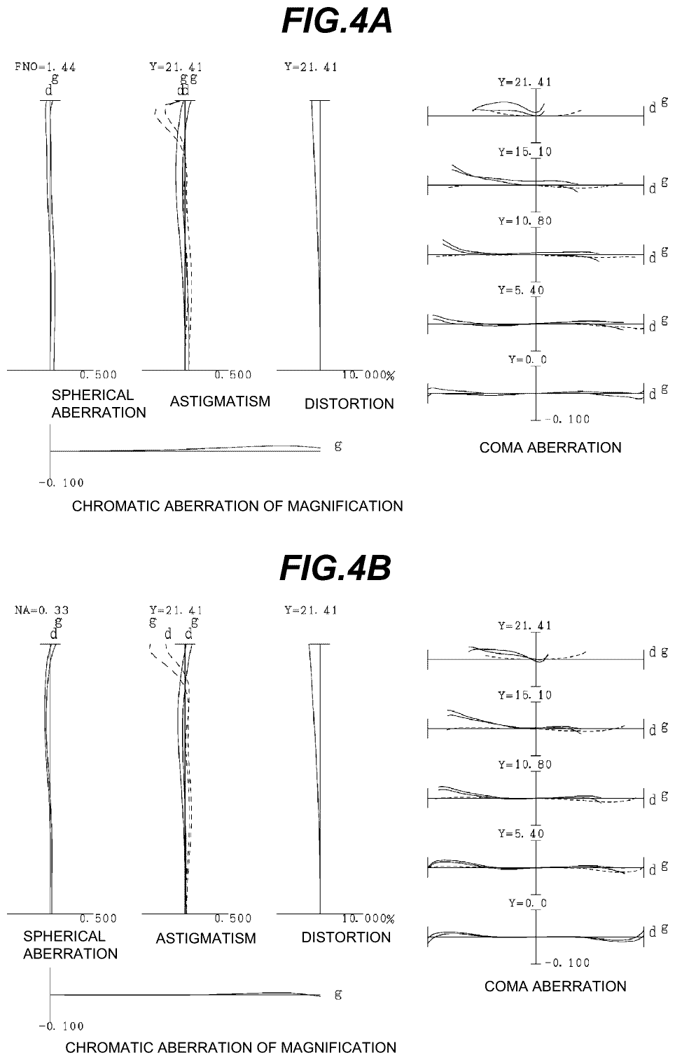

The second example will be described by using FIG. 3, FIG. 4, and the table 2. FIG. 3 is a diagram illustrating a lens configuration of the optical system according to the second example. The optical system OL(2) according to the second example is formed from a first lens group G1 having positive refractive power, a second lens group G2 having positive refractive power, a third lens group G3 having positive refractive power, and a fourth lens group G4 having negative refractive power, which are arranged in order from the object side along the optical axis. In focusing from an object at infinity to an object at a short distance, the second lens group G2 and the third lens group G3 move to the object side along the optical axis in different loci (different in movement amounts), and intervals between the neighboring lens groups are thereby changed. Note that in focusing, positions of the first lens group G1 and the fourth lens group G4 are fixed with respect to the image surface I.

The aperture stop S is disposed between the first lens group G1 and the second lens group G2. In focusing, the position of the aperture stop S is fixed with respect to the image surface front group GA, the second lens group G2 and the third lens group G3 constitute the intermediate group GM, and the fourth lens group G4 constitutes the rear group GR. Further, the second lens group G2 corresponds to the first focusing lens group GF1, and the third lens group G3 corresponds to the second focusing lens group GF2.

The first lens group G1 is formed from a positive meniscus lens L11 having a convex surface facing the object side, a positive meniscus lens L12 having a convex surface facing the object side, and a negative meniscus lens L13 having a convex surface facing the object side, and the above lenses are arranged in order from the object side along the optical axis. A lens surface of the positive meniscus lens L12 on the object side is an aspherical surface.

The second lens group G2 is formed from a cemented negative lens, in which a biconcave negative lens L21 and a positive meniscus lens L22 having a convex surface facing the object side are joined together, and a biconvex positive lens L23, and the above lenses are arranged in order from the object side along the optical axis. The positive lens L23 is a hybrid type lens which is configured such that a resin layer is provided on a surface of a glass-made lens main body on the image surface side. The surface of the resin layer on the image surface side is an aspherical surface, and the positive lens L23 is a composite type aspherical lens. In [lens data] which will be described later, a surface number 11 denotes a surface of the lens main body on the object side, a surface number 12 denotes a surface of the lens main body on the image surface side and a surface of the resin layer on the object side (the surface on which both of those are joined together), and a surface number 13 denotes a surface of the resin layer on the image surface side.

The third lens group G3 is formed from a biconvex positive lens L31. The positive lens L31 is a hybrid type lens which is configured such that a resin layer is provided on a surface of a glass-made lens main body on the image surface side. The surface of the resin layer on the image surface side is an aspherical surface, and the positive lens L31 is a composite type aspherical lens. In [lens data] which will be described later, a surface number 14 denotes a surface of the lens main body on the object side, a surface number 15 denotes a surface of the lens main body on the image surface side and a surface of the resin layer on the object side (the surface on which both of those are joined together), and a surface number 16 denotes a surface of the resin layer on the image surface side.

The fourth lens group G4 is formed from a cemented positive lens in which a positive meniscus lens L41 having a concave surface facing the object side and a negative meniscus lens L42 having a concave surface facing the object side are joined together, a biconcave negative lens L43, and a plano-concave negative lens L44 having a flat surface facing the image surface side, and the above lenses are arranged in order from the object side along the optical axis. The image surface I is arranged on the image side of the fourth lens group G4.

The following table 2 raises values of data of the optical system according to the second example.

TABLE 2
[General Data]

| | |
|---|---|
| f = 48.500 | FNO = 1.442 |
| ω = 24.256 | Y = 21.413 |
| TL = 92.309 | Bf = 12.113 |
| fA = 144.537 | fR = −64.985 |
| fF1 = 141.932 | fF2 = 42.786 |
| fSa = 144.537 | fSr = 45.388 |
| fe = −398.038 | |

[Lens Data]

| Surface | | | | |
|---|---|---|---|---|
| Number | R | D | nd | νd |
| 1 | 44.354 | 3.671 | 1.83481 | 42.73 |
| 2 | 68.031 | 2.679 | | |
| 3* | 30.946 | 5.657 | 1.83481 | 42.73 |
| 4 | 119.179 | 0.686 | | |
| 5 | 456.720 | 0.900 | 1.59270 | 35.27 |
| 6 | 23.170 | 5.704 | | |
| 7 | ∞ | (D7) | | (Aperture |
| | | | | Stop S) |
| 8 | −19.295 | 0.900 | 1.64769 | 33.72 |
| 9 | 24.301 | 6.226 | 1.83481 | 42.73 |
| 10 | 222.101 | 0.100 | | |
| 11 | 51.221 | 7.224 | 1.77250 | 49.62 |
| 12 | −44.866 | 0.100 | 1.56093 | 36.64 |
| 13* | −44.287 | (D13) | | |
| 14 | 51.773 | 6.423 | 1.77250 | 49.62 |
| 15 | −154.916 | 0.100 | 1.56093 | 36.64 |
| 16* | −74.031 | (D16) | | |
| 17 | −510.487 | 12.769 | 1.85026 | 32.35 |
| 18 | −20.236 | 1.000 | 1.90265 | 35.73 |
| 19 | −61.076 | 0.100 | | |
| 20 | −98.851 | 1.024 | 1.75520 | 27.57 |
| 21 | 48.753 | 4.694 | | |
| 22 | −235.917 | 1.300 | 1.59270 | 35.27 |
| 23 | ∞ | Bf | | |

[Aspherical Surface Data]
3rd Surface
κ = 1.0000, A4 = 1.39886E−06, A6 = 7.46585E−09,
A8 = −1.84946E−11, A10 = 7.06419E−14
13th Surface
κ = 1.0000, A4 = 6.25043E−06, A6 = 7.63434E−09,
A8 = −2.42103E−12, A10 = 2.61079E−14
16th Surface
κ = 1.0000, A4 = 1.51632E−05, A6 = −2.12876E−09,
A8 = 3.12457E−11, A10 = −4.64496E−14

[Variable Distance Data]

| | Upon focusing | Upon focusing |
|---|---|---|
| | on infinity | on a short-distance |
| | f = 48.500 | β = −0.03333 |
| D0 | ∞ | 1427.370 |
| D7 | 12.239 | 11.399 |
| D13 | 5.200 | 4.948 |
| D16 | 1.500 | 2.591 |
| Bf | 12.113 | 12.113 |

[Lens Group Data]

| | First | Focal |
|---|---|---|
| Group | surface | length |
| G1 | 1 | 144.537 |
| G2 | 8 | 141.932 |
| G3 | 14 | 42.786 |
| G4 | 17 | −64.985 |

FIG. 4(A) illustrates diagrams of various aberrations of the optical system according to the second example upon focusing on infinity. FIG. 4(B) illustrates diagrams of various aberrations of the optical system according to the second example upon focusing on a short distance object. Based on each of the diagrams of various aberrations, it may be understood that not only upon focusing on infinity but also focusing on a short distance object, the optical system according to the second example properly corrects various aberrations and exhibits excellent image formation performance.

### Third Example

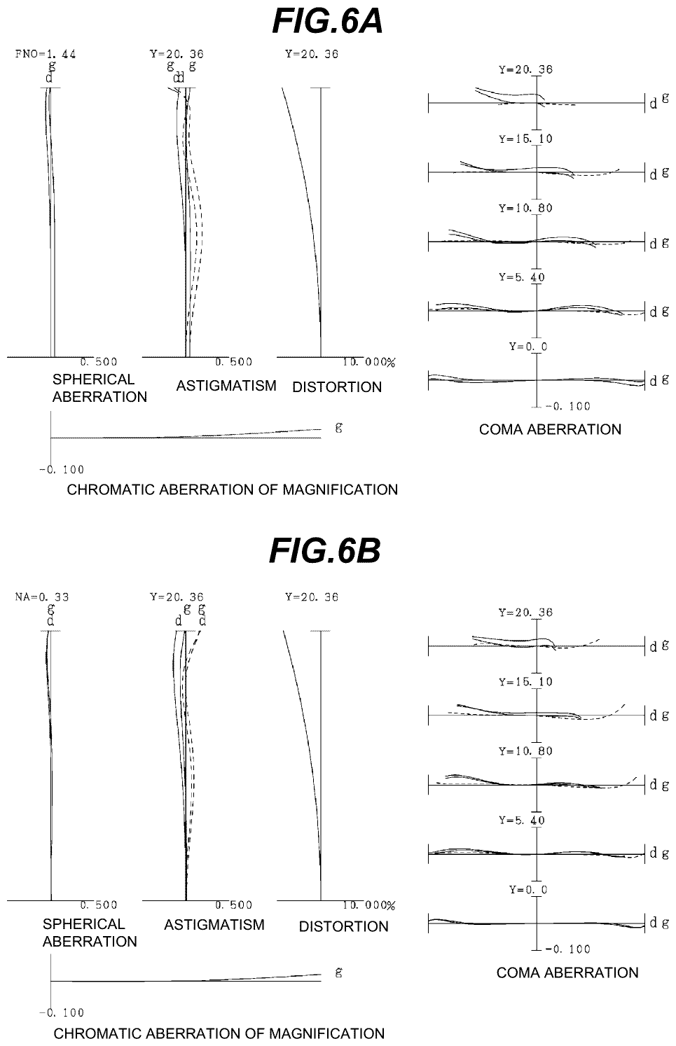

The third example will be described by using FIG. 5, FIG. 6, and the table 3. FIG. 5 is a diagram illustrating a lens configuration of the optical system according to the third example. The optical system OL(3) according to the third example is formed from a first lens group G1 having positive refractive power, a second lens group G2 having positive refractive power, a third lens group G3 having positive refractive power, and a fourth lens group G4 having negative refractive power, which are arranged in order from the object side along the optical axis. In focusing from an object at infinity to an object at a short distance, the second lens group G2 and the third lens group G3 move to the object side along the optical axis in different loci (different in movement amounts), and intervals between the neighboring lens groups are thereby changed. Note that in focusing, positions of the first lens group G1 and the fourth lens group G4 are fixed with respect to the image surface I.

The aperture stop S is disposed between the first lens group G1 and the second lens group G2. In focusing, the position of the aperture stop S is fixed with respect to the image surface I. In the present example, the first lens group G1 constitutes the front group GA, the second lens group G2 and the third lens group G3 constitute the intermediate group GM, and the fourth lens group G4 constitutes the rear group GR. Further, the second lens group G2 corresponds to the first focusing lens group GF1, and the third lens group G3 corresponds to the second focusing lens group GF2.

The first lens group G1 is formed from a plano-concave negative lens L11 having a flat surface facing the object side and a cemented positive lens in which a biconvex positive lens L12 and a biconcave negative lens L13 are joined together, and the above lenses are arranged in order from the object side along the optical axis.

The second lens group G2 is formed from a cemented negative lens, in which a biconcave negative lens L21 and a positive meniscus lens L22 having a convex surface facing the object side are joined together, and a biconvex positive lens L23, and the above lenses are arranged in order from the object side along the optical axis. The positive lens L23 is a hybrid type lens which is configured such that a resin layer is provided on a surface of a glass-made lens main body on the image surface side. The surface of the resin layer on the image surface side is an aspherical surface, and the positive lens L23 is a composite type aspherical lens. In [lens data] which will be described later, a surface number 10 denotes a surface of the lens main body on the object side, a surface number 11 denotes a surface of the lens main body on the image surface side and a surface of the resin layer on the object side (the surface on which both of those are joined together), and a surface number 12 denotes a surface of the resin layer on the image surface side.

The third lens group G3 is formed from a biconvex positive lens L31. The positive lens L31 is a hybrid type lens which is configured such that a resin layer is provided on a surface of a glass-made lens main body on the image surface side. The surface of the resin layer on the image surface side is an aspherical surface, and the positive lens L31 is a composite type aspherical lens. In [lens data] which will be described later, a surface number 13 denotes a surface of the lens main body on the object side, a surface number 14 denotes a surface of the lens main body on the image surface side and a surface of the resin layer on the object side (the surface on which both of those are joined together), and a surface number 15 denotes a surface of the resin layer on the image surface side.

The fourth lens group G4 is formed from a cemented positive lens in which a biconcave negative lens L41 and a biconvex positive lens L42 are joined together, a negative meniscus lens L43 having a concave surface facing the object side, and a plano-concave negative lens L44 having a flat surface facing the image surface side, and the above lenses are arranged in order from the object side along the optical axis. The image surface I is arranged on the image side of the fourth lens group G4.

The following table 3 raises values of data of the optical system according to the third example.

TABLE 3
[General Data]

| | |
|---|---|
| f = 36.050 | FNO = 1.442 |
| ω = 31.808 | Y = 20.358 |
| TL = 80.563 | Bf = 12.113 |
| fA = 175.868 | fR = −103.535 |
| fF1 = 100.040 | fF2 = 50.621 |
| fSa = 175.868 | fSr = 38.887 |
| fe = −55.498 | |

[Lens Data]

| Surface | | | | |
|---|---|---|---|---|
| Number | R | D | nd | νd |
| 1 | ∞ | 1.000 | 1.48749 | 70.32 |
| 2 | 27.539 | 0.516 | | |
| 3 | 31.701 | 6.527 | 1.83481 | 42.73 |
| 4 | −58.413 | 0.900 | 1.72825 | 28.38 |
| 5 | 142.453 | 2.116 | | |
| 6 | ∞ | (D6) | | (Aperture |
| | | | | Stop S) |
| 7 | −23.996 | 0.900 | 1.59270 | 35.27 |
| 8 | 27.203 | 5.321 | 1.83481 | 42.73 |
| 9 | 403.040 | 0.124 | | |
| 10 | 75.848 | 5.128 | 1.83481 | 42.73 |
| 11 | −58.068 | 0.100 | 1.56093 | 36.64 |
| 12* | −54.564 | (D12) | | |
| 13 | 1598.814 | 5.843 | 1.75500 | 52.34 |
| 14 | −40.976 | 0.100 | 1.56093 | 36.64 |
| 15* | −38.468 | (D15) | | |
| 16 | −119.723 | 1.000 | 1.72825 | 28.38 |
| 17 | 34.445 | 12.585 | 1.90265 | 35.73 |
| 18 | −36.878 | 0.100 | | |
| 19 | −43.561 | 2.607 | 1.84666 | 23.80 |
| 20 | −236.442 | 4.820 | | |
| 21 | −32.894 | 1.300 | 1.59270 | 35.27 |
| 22 | ∞ | Bf | | |

[Aspherical Surface Data]
12th Surface
κ = 1.0000, A4 = 1.47674E−05, A6 = −1.08656E−08,
A8 = 8.95106E−12, A10 = −3.68687E−15
15th Surface
κ = 1.0000, A4 = 4.77686E−06, A6 = 1.19495E−08,
A8 = 1.37062E−11, A10 = 3.29111E−14

[Variable Distance Data]

| | Upon focusing | Upon focusing |
|---|---|---|
| | on infinity | on a short-distance object |
| | f = 36.050 | β = −0.03333 |
| D0 | ∞ | 1081.803 |
| D6 | 12.622 | 10.849 |
| D12 | 3.342 | 4.228 |
| D15 | 1.500 | 2.387 |
| Bf | 12.113 | 12.113 |

[Lens Group Data]

| | First | Focal |
|---|---|---|
| Group | surface | length |
| G1 | 1 | 175.868 |
| G2 | 7 | 100.040 |
| G3 | 13 | 50.621 |
| G4 | 16 | −103.535 |

FIG. 6(A) illustrates diagrams of various aberrations of the optical system according to the third example upon focusing on infinity. FIG. 6(B) illustrates diagrams of various aberrations of the optical system according to the third example upon focusing on a short distance object. Based on each of the diagrams of various aberrations, it may be understood that not only upon focusing on infinity but also focusing on a short distance object, the optical system according to the third example properly corrects various aberrations and exhibits excellent image formation performance.

### Fourth Example

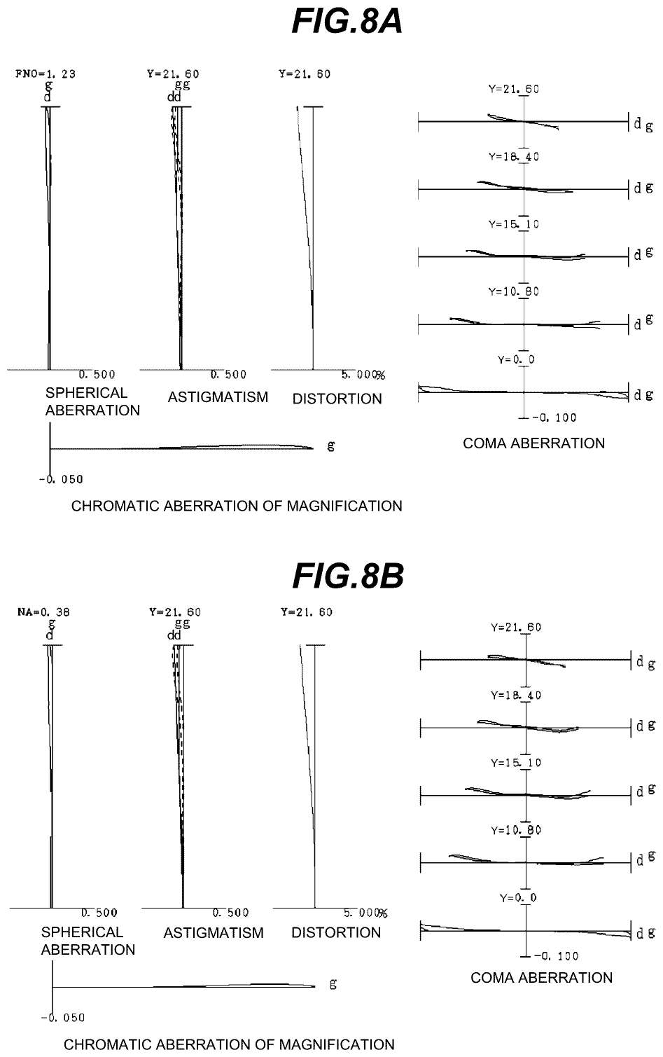

The fourth example will be described by using FIG. 7, FIG. 8, and the table 4. FIG. 7 is a diagram illustrating a lens configuration of the optical system according to the fourth example. The optical system OL(4) according to the fourth example is formed from a first lens group G1 having positive refractive power, a second lens group G2 having positive refractive power, a third lens group G3 having positive refractive power, and a fourth lens group G4 having negative refractive power, which are arranged in order from the object side along the optical axis. In focusing from an object at infinity to an object at a short distance, the second lens group G2 and the third lens group G3 move to the object side along the optical axis in different loci (different in movement amounts), and intervals between the neighboring lens groups are thereby changed. Note that in focusing, positions of the first lens group G1 and the fourth lens group G4 are fixed with respect to the image surface I.

The aperture stop S is disposed between the first lens group G1 and the second lens group G2. In focusing, the position of the aperture stop S is fixed with respect to the image surface front group GA, the second lens group G2 and the third lens group G3 constitute the intermediate group GM, and the fourth lens group G4 constitutes the rear group GR. Further, the second lens group G2 corresponds to the first focusing lens group GF1, and the third lens group G3 corresponds to the second focusing lens group GF2.

The first lens group G1 is formed from a negative meniscus lens L11 having a convex surface facing the object side, a negative meniscus lens L12 having a convex surface facing the object side, a cemented positive lens in which a biconvex positive lens L13 and a biconcave negative lens L14 are joined together, a cemented negative lens in which a biconcave negative lens L15 and a biconvex positive lens L16 are joined together, a biconvex positive lens L17, a biconvex positive lens L18, and a cemented negative lens in which a biconcave negative lens L19 and a biconvex positive lens L110 are joined together, and the above lenses are arranged in order from the object side along the optical axis. A lens surface of the negative meniscus lens L12 on the image surface side is an aspherical surface.

The second lens group G2 is formed from a biconcave negative lens L21 and a biconvex positive lens L22, and the above lenses are arranged in order from the object side along the optical axis.

The third lens group G3 is formed from a positive meniscus lens L31 having a convex surface facing the object side and a positive meniscus lens L32 having a convex surface facing the object side, and the above lenses are arranged in order from the object side along the optical axis. A lens surface of the positive meniscus lens L31 on the image surface side is an aspherical surface. A lens surface of the positive meniscus lens L32 on the image surface side is an aspherical surface.

The fourth lens group G4 is formed from a positive meniscus lens L41 having a concave surface facing the object side and a biconcave negative lens L42, and the above lenses are arranged in order from the object side along the optical axis. The image surface I is arranged on the image side of the fourth lens group G4.

The following table 4 raises values of data of the optical system according to the fourth example.

TABLE 4
[General Data]

| | |
|---|---|
| f = 34.301 | FNO = 1.230 |
| ω = 32.681 | Y = 21.600 |
| TL = 145.455 | Bf = 11.456 |
| fA = 60.284 | fR = −155.922 |
| fF1 = 493.944 | fF2 = 77.173 |
| fSa = 60.284 | fSr = 87.232 |
| fe = −52.564 | |

[Lens Data]

| Surface | | | | |
|---|---|---|---|---|
| Number | R | D | nd | νd |
| 1 | 96.047 | 2.000 | 1.48749 | 70.31 |
| 2 | 28.087 | 9.219 | | |
| 3 | 66.416 | 1.800 | 1.58887 | 61.13 |
| 4* | 42.041 | 2.388 | | |
| 5 | 47.837 | 8.233 | 2.00100 | 29.12 |
| 6 | −645.006 | 1.500 | 1.49782 | 82.57 |
| 7 | 35.910 | 11.438 | | |
| 8 | −33.782 | 1.500 | 1.85451 | 25.15 |
| 9 | 80.983 | 5.585 | 1.56732 | 42.58 |
| 10 | −217.995 | 0.200 | | |
| 11 | 237.343 | 8.059 | 2.00069 | 25.46 |
| 12 | −51.294 | 0.200 | | |
| 13 | 44.432 | 10.369 | 1.59349 | 67.00 |
| 14 | −144.859 | 2.518 | | |
| 15 | −99.402 | 1.500 | 1.69895 | 30.13 |
| 16 | 27.200 | 14.331 | 1.59319 | 67.90 |
| 17 | −86.856 | 2.000 | | |
| 18 | ∞ | (D18) | | (Aperture |
| | | | | Stop S) |
| 19 | −38.048 | 1.300 | 1.68376 | 37.64 |
| 20 | 178.836 | 0.200 | | |
| 21 | 41.104 | 9.000 | 1.59349 | 67.00 |
| 22 | −68.514 | (D22) | | |
| 23 | 36.893 | 6.200 | 1.85108 | 40.12 |
| 24* | 75.937 | 4.486 | | |
| 25 | 157.349 | 2.500 | 1.77387 | 47.25 |
| 26* | 161.771 | (D26) | | |
| 27 | −597.200 | 3.598 | 1.94595 | 17.98 |
| 28 | −68.766 | 1.916 | | |
| 29 | −40.274 | 1.500 | 1.73037 | 32.23 |
| 30 | 834.207 | Bf | | |

[Aspherical Surface Data]
4th Surface
κ = 1.0000, A4 = −1.39004E−06, A6 = −9.76153E−10,
A8 = −1.35116E−12, A10 = −7.50960E−16
24th Surface
κ = 1.0000, A4 = −4.67477E−06, A6 = −5.48120E−09,
A8 = 3.46635E−11, A10 = −1.11525E−14
26th Surface
κ = 1.0000, A4 = 2.09207E−05, A6 = 2.10855E−08,
A8 = −1. 68530E−11, A10 = −2.78769E−14

[Variable Distance Data]

| | Upon focusing | Upon focusing |
|---|---|---|
| | on infinity | on a short-distance |
| | f = 34.301 | B = −0.03333 |
| D0 | ∞ | 993.600 |
| D18 | 13.152 | 11.783 |
| D22 | 2.047 | 2.000 |
| D26 | 5.262 | 6.678 |
| Bf | 11.456 | 11.456 |

[Lens Group Data]

| | First | Focal |
|---|---|---|
| Group | surface | length |
| G1 | 1 | 60.284 |
| G2 | 19 | 493.944 |
| G3 | 23 | 77.173 |
| G4 | 27 | −155.922 |

FIG. 8(A) illustrates diagrams of various aberrations of the optical system according to the fourth example upon focusing on infinity. FIG. 8(B) illustrates diagrams of various aberrations of the optical system according to the fourth example upon focusing on a short distance object. Based on each of the diagrams of various aberrations, it may be understood that not only upon focusing on infinity but also focusing on a short distance object, the optical system according to the fourth example properly corrects various aberrations and exhibits excellent image formation performance.

### Fifth Example

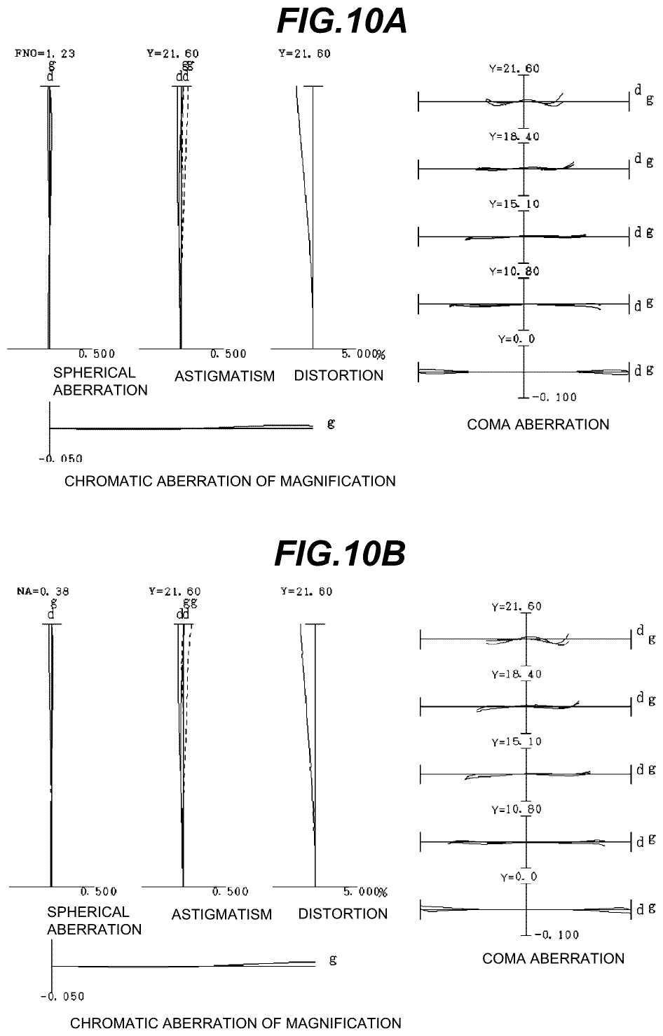

The fifth example will be described by using FIG. 9, FIG. 10, and the table 5. FIG. 9 is a diagram illustrating a lens configuration of the optical system according to the fifth example. The optical system OL(5) according to the fifth example is formed from a first lens group G1 having positive refractive power, a second lens group G2 having positive refractive power, a third lens group G3 having positive refractive power, and a fourth lens group G4 having negative refractive power, which are arranged in order from the object side along the optical axis. In focusing from an object at infinity to an object at a short distance, the second lens group G2 and the third lens group G3 move to the object side along the optical axis in different loci (different in movement amounts), and intervals between the neighboring lens groups are thereby changed. Note that in focusing, positions of the first lens group G1 and the fourth lens group G4 are fixed with respect to the image surface I.

The aperture stop S is disposed between the first lens group G1 and the second lens group G2. In focusing, the position of the aperture stop S is fixed with respect to the image surface I. In the present example, the first lens group G1 constitutes the front group GA, the second lens group G2 and the third lens group G3 constitute the intermediate group GM, and the fourth lens group G4 constitutes the rear group GR. Further, the second lens group G2 corresponds to the first focusing lens group GF1, and the third lens group G3 corresponds to the second focusing lens group GF2.

The first lens group G1 is formed from a negative meniscus lens L11 having a convex surface facing the object side, a negative meniscus lens L12 having a convex surface facing the object side, a cemented positive lens in which a biconvex positive lens L13 and a biconcave negative lens L14 are joined together, a cemented negative lens in which a biconcave negative lens L15 and a biconvex positive lens L16 are joined together, a biconvex positive lens L17, a biconvex positive lens L18, and a cemented negative lens in which a biconcave negative lens L19 and a biconvex positive lens L110 are joined together, and the above lenses are arranged in order from the object side along the optical axis. A lens surface of the negative meniscus lens L12 on the image surface side is an aspherical surface.

The second lens group G2 is formed from a biconcave negative lens L21 and a biconvex positive lens L22, and the above lenses are arranged in order from the object side along the optical axis.

The third lens group G3 is formed from a cemented positive lens, in which a biconvex positive lens L31 and a biconcave negative lens L32 are joined together, and a negative meniscus lens L33 having a concave surface facing the object side, and the above lenses are arranged in order from the object side along the optical axis. Both lens surfaces of the negative meniscus lens L33 are aspherical surfaces.

The fourth lens group G4 is formed from a positive meniscus lens L41 having a concave surface facing the object side and a biconcave negative lens L42, and the above lenses are arranged in order from the object side along the optical axis. The image surface I is arranged on the image side of the fourth lens group G4.

The following table 5 raises values of data of the optical system according to the fifth example.

TABLE 5
[General Data]

| | |
|---|---|
| f = 34.300 | FNO = 1.230 |
| ω = 32.676 | Y = 21.600 |
| TL = 145.455 | Bf = 11.455 |
| fA = 65.214 | fR = −165.983 |
| fF1 = 629.134 | fF2 = 70.033 |
| fSa = 65.214 | fSr = 80.285 |
| fe = −56.319 | |

[Lens Data]

| Surface | | | | |
|---|---|---|---|---|
| Number | R | D | nd | νd |
| 1 | 72.093 | 2.000 | 1.48749 | 70.31 |
| 2 | 27.081 | 11.466 | | |
| 3 | 105.428 | 1.800 | 1.51680 | 64.13 |
| 4* | 49.653 | 1.202 | | |
| 5 | 47.334 | 7.850 | 2.00100 | 29.12 |
| 6 | −2063.273 | 1.500 | 1.49782 | 82.57 |
| 7 | 34.755 | 11.769 | | |
| 8 | −32.107 | 1.500 | 1.85451 | 25.15 |
| 9 | 82.520 | 5.950 | 1.67003 | 47.14 |
| 10 | −198.954 | 0.200 | | |
| 11 | 391.739 | 7.906 | 2.00069 | 25.46 |
| 12 | −48.789 | 0.200 | | |
| 13 | 41.194 | 11.022 | 1.59349 | 67.00 |
| 14 | −135.101 | 1.669 | | |
| 15 | −112.838 | 1.500 | 1.73037 | 32.23 |
| 16 | 27.200 | 13.277 | 1.59319 | 67.90 |
| 17 | −122.895 | 2.000 | | |
| 18 | ∞ | (D18) | | (Aperture |
| | | | | Stop S) |
| 19 | −42.056 | 1.300 | 1.68376 | 37.64 |
| 20 | 240.838 | 0.200 | | |
| 21 | 38.726 | 7.500 | 1.59319 | 67.90 |
| 22 | −118.915 | (D22) | | |
| 23 | 42.490 | 7.198 | 1.83481 | 42.73 |
| 24 | −124.265 | 1.500 | 1.68376 | 37.64 |
| 25 | 96.988 | 5.998 | | |
| 26* | −257.390 | 2.500 | 1.77387 | 47.25 |
| 27* | −264.366 | (D27) | | |
| 28 | −531.885 | 3.492 | 1.94595 | 17.98 |
| 29 | −71.866 | 1.741 | | |
| 30 | −43.260 | 1.500 | 1.73037 | 32.23 |
| 31 | 848.999 | Bf | | |

[Aspherical Surface Data]
4th Surface
κ = 1.0000, A4 = −1.34774E−06, A6 = −9.46928E−10,
A8 = −1.46439E−12, A10 = −3.40961E−16
26th Surface
κ = 1.0000, A4 = −7.46350E−06, A6 = 6.20342E−08,
A8 = −1.63956E−10, A10 = 4.03734E−14
27th Surface
κ = 1.0000, A4 = 9.35182E−06, A6 = 7.30804E−08,
A8 = −1.33669E−10, A10 = 1.93285E−14

[Variable Distance Data]

| | Upon focusing | Upon focusing |
|---|---|---|
| | on infinity | on a short-distance |
| | f=34.300 | β = −0.03333 |
| D0 | ∞ | 994.412 |
| D18 | 12.611 | 11.246 |
| D22 | 2.244 | 2.268 |
| D27 | 3.404 | 4.744 |
| Bf | 11.455 | 11.455 |

[Lens Group Data]

| | First | Focal |
|---|---|---|
| Group | surface | length |
| G1 | 1 | 65.214 |
| G2 | 19 | 629.134 |
| G3 | 23 | 70.033 |
| G4 | 27 | −165.983 |

FIG. 10(A) illustrates diagrams of various aberrations of the optical system according to the fifth example upon focusing on infinity. FIG. 10(B) illustrates diagrams of various aberrations of the optical system according to the fifth example upon focusing on a short distance object. Based on each of the diagrams of various aberrations, it may be understood that not only upon focusing on infinity but also focusing on a short distance object, the optical system according to the fifth example properly corrects various aberrations and exhibits excellent image formation performance.

### Sixth Example

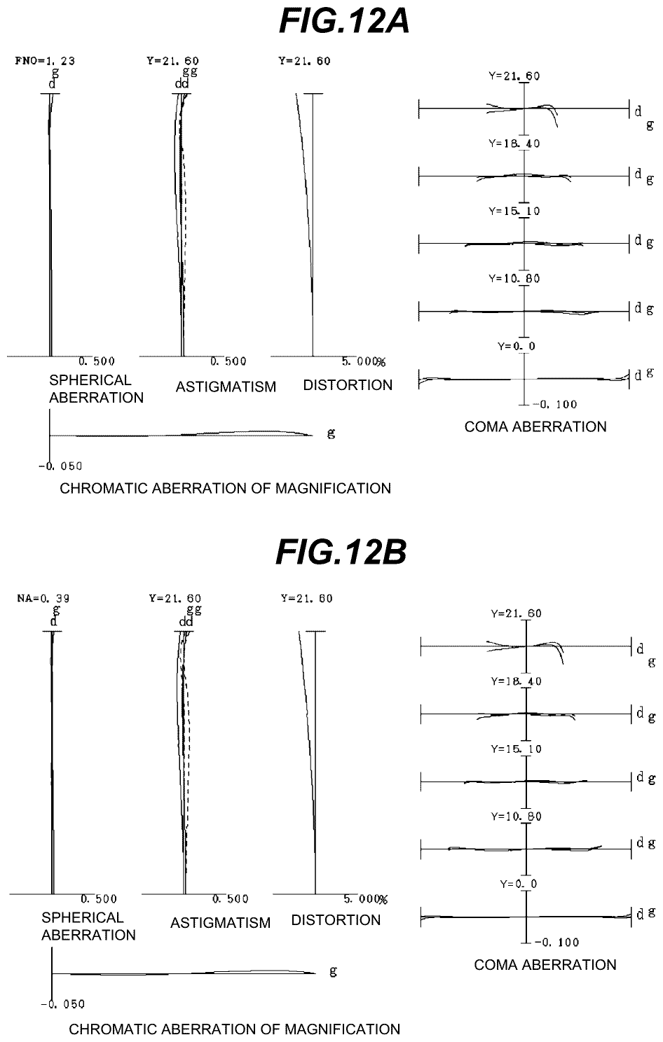

The sixth example will be described by using FIG. 11, FIG. 12, and the table 6. FIG. 11 is a diagram illustrating a lens configuration of the optical system according to the sixth example. The optical system OL(6) according to the sixth example is formed from a first lens group G1 having positive refractive power, a second lens group G2 having positive refractive power, a third lens group G3 having positive refractive power, and a fourth lens group G4 having negative refractive power, which are arranged in order from the object side along the optical axis. In focusing from an object at infinity to an object at a short distance, the second lens group G2 and the third lens group G3 move to the object side along the optical axis in different loci (different in movement amounts), and intervals between the neighboring lens groups are thereby changed. Note that in focusing, positions of the first lens group G1 and the fourth lens group G4 are fixed with respect to the image surface I.

The aperture stop S is disposed between the first lens group G1 and the second lens group G2. In focusing, the position of the aperture stop S is fixed with respect to the image surface I. In the present example, the first lens group G1 constitutes the front group GA, the second lens group G2 and the third lens group G3 constitute the intermediate group GM, and the fourth lens group G4 constitutes the rear group GR. Further, the second lens group G2 corresponds to the first focusing lens group GF1, and the third lens group G3 corresponds to the second focusing lens group GF2.

The first lens group G1 is formed from a negative meniscus lens L11 having a convex surface facing the object side, a cemented positive lens in which a biconvex positive lens L12 and a biconcave negative lens L13 are joined together, a cemented negative lens in which a biconcave negative lens L14 and a positive meniscus lens L15 having a convex surface facing the object side are joined together, a cemented positive lens in which a biconvex positive lens L16 and a negative meniscus lens L17 having a concave surface facing the object side are joined together, a positive meniscus lens L18 having a convex surface facing the object side, and a cemented negative lens in which a biconvex positive lens L19 and a biconcave negative lens L110 are joined together, and the above lenses are arranged in order from the object side along the optical axis.

The second lens group G2 is formed from a negative meniscus lens L21 having a concave surface facing the object side, a biconvex positive lens L22, and a negative meniscus lens L23 having a concave surface facing the object side, and the above lenses are arranged in order from the object side along the optical axis. Both lens surfaces of the negative meniscus lens L23 are aspherical surfaces.

The third lens group G3 is formed from a positive meniscus lens L31 having a concave surface facing the object side and a negative meniscus lens L32 having a concave surface facing the object side, and the above lenses are arranged in order from the object side along the optical axis. A lens surface of the positive meniscus lens L31 on the image surface side is an aspherical surface. A lens surface of the negative meniscus lens L32 on the object side is an aspherical surface.

The fourth lens group G4 is formed from a cemented negative lens in which a positive meniscus lens L41 having a concave surface facing the object side and a biconcave negative lens L42 are joined together, and the above lenses are arranged in order from the object side along the optical axis. The image surface I is arranged on the image side of the fourth lens group G4.

The following table 6 raises values of data of the optical system according to the sixth example.

TABLE 6
[General Data]

| | |
|---|---|
| f = 34.300 | FNO = 1.228 |
| ω = 32.697 | Y = 21.600 |
| TL = 155.455 | Bf = 11.455 |
| fA = 75.723 | fR = −60.553 |
| fF1 = 69.782 | fF2 = 58.312 |
| fSa = 75.723 | fSr = 61.522 |
| fe = −26.934 | |

[Lens Data]

| Surface | | | | |
|---|---|---|---|---|
| Number | R | D | nd | νd |
| 1 | 81.239 | 2.000 | 1.59349 | 67.00 |
| 2 | 29.403 | 11.650 | | |
| 3 | 97.417 | 9.313 | 1.90265 | 35.77 |
| 4 | −66.592 | 1.500 | 1.51742 | 52.20 |
| 5 | 37.688 | 11.679 | | |
| 6 | −36.576 | 3.997 | 1.73037 | 32.23 |
| 7 | 57.862 | 5.275 | 1.94595 | 17.98 |
| 8 | 437.731 | 0.200 | | |
| 9 | 137.189 | 14.813 | 1.84850 | 43.79 |
| 10 | −31.982 | 1.500 | 1.85451 | 25.15 |
| 11 | −58.341 | 0.200 | | |
| 12 | 50.708 | 7.542 | 1.59319 | 67.90 |
| 13 | 173.475 | 0.200 | | |
| 14 | 50.175 | 13.955 | 1.59319 | 67.90 |
| 15 | −45.041 | 1.500 | 1.64769 | 33.73 |
| 16 | 49.712 | 5.575 | | |
| 17 | ∞ | (D17) | | (Aperture |
| | | | | Stop S) |
| 18 | −42.349 | 1.500 | 1.61266 | 44.46 |
| 19 | −303.712 | 0.200 | | |
| 20 | 30.793 | 9.330 | 1.59349 | 67.00 |
| 21 | −73.903 | 0.200 | | |
| 22* | −74.759 | 2.000 | 1.88202 | 37.23 |
| 23* | −78.949 | (D23) | | |
| 24 | −117.169 | 3.976 | 1.77387 | 47.25 |
| 25* | −26.746 | 0.564 | | |
| 26* | −30.019 | 3.648 | 1.58887 | 61.13 |
| 27 | −41.705 | (D27) | | |
| 28 | −65.973 | 6.366 | 1.94595 | 17.98 |
| 29 | −27.107 | 1.500 | 1.77047 | 29.74 |
| 30 | 90.644 | Bf | | |

[Aspherical Surface Data]
22nd Surface
κ = 1.0000, A4 = 1.73688E−05, A6 = 9.00046E−08,
A8 = −3.66508E−10, A10 = 3.45942E−13
23rd Surface
κ = 1.0000, A4 = 2.84915E−05, A6 = 9.29029E−08,
A8 = −3.03655E−10, A10 = 1.96904E−13
25th Surface
κ = 1.0000, A4 = 5.79685E−05, A6 = −1.66905E−07,
A8 = 4.04878E−10, A10 = −3.50430E−13
26th Surface
κ = 1.0000, A4 = 6.83994E−05, A6 = −2.43826E−07,
A8 = 5.82093E−10, A10 = −5.75702E−13

[Variable Distance Data]

| | Upon focusing | Upon focusing |
|---|---|---|
| | on infinity | on a short-distance object |
| | f = 34.300 | β = −0.03333 |
| D0 | ∞ | 988.825 |
| D17 | 13.387 | 12.265 |
| D23 | 8.429 | 8.961 |
| D27 | 2.000 | 2.591 |
| Bf | 11.455 | 11.455 |

[Lens Group Data]

| | First | Focal |
|---|---|---|
| Group | surface | length |
| G1 | 1 | 75.723 |
| G2 | 18 | 69.782 |
| G3 | 24 | 58.312 |
| G4 | 28 | −60.553 |

FIG. 12(A) illustrates diagrams of various aberrations of the optical system according to the sixth example upon focusing on infinity. FIG. 12(B) illustrates diagrams of various aberrations of the optical system according to the sixth example upon focusing on a short distance object. Based on each of the diagrams of various aberrations, it may be understood that not only upon focusing on infinity but also focusing on a short distance object, the optical system according to the sixth example properly corrects various aberrations and exhibits excellent image formation performance.

### Seventh Example

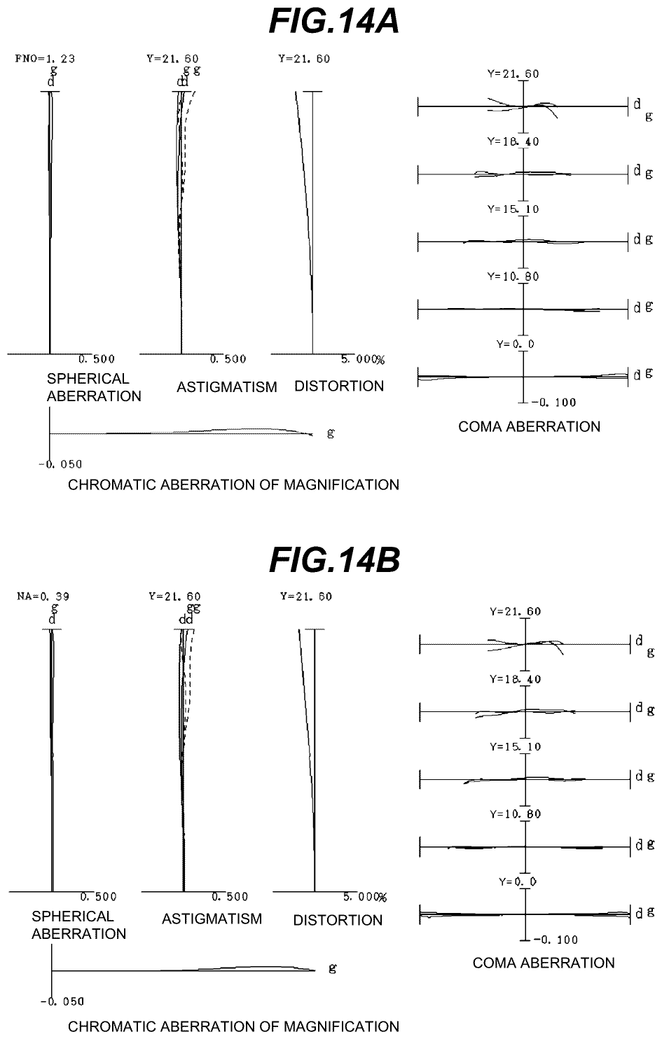

The seventh example will be described by using FIG. 13, FIG. 14, and the table 7. FIG. 13 is a diagram illustrating a lens configuration of the optical system according to the seventh example. The optical system OL(7) according to the seventh example is formed from a first lens group G1 having positive refractive power, a second lens group G2 having positive refractive power, a third lens group G3 having positive refractive power, and a fourth lens group G4 having negative refractive power, which are arranged in order from the object side along the optical axis. In focusing from an object at infinity to an object at a short distance, the second lens group G2 and the third lens group G3 move to the object side along the optical axis in different loci (different in movement amounts), and intervals between the neighboring lens groups are thereby changed. Note that in focusing, positions of the first lens group G1 and the fourth lens group G4 are fixed with respect to the image surface I.

The aperture stop S is disposed between the first lens group G1 and the second lens group G2. In focusing, the position of the aperture stop S is fixed with respect to the image surface I. In the present example, the first lens group G1 constitutes the front group GA, the second lens group G2 and the third lens group G3 constitute the intermediate group GM, and the fourth lens group G4 constitutes the rear group GR. Further, the second lens group G2 corresponds to the first focusing lens group GF1, and the third lens group G3 corresponds to the second focusing lens group GF2.

The first lens group G1 is formed from a negative meniscus lens L11 having a convex surface facing the object side, a cemented positive lens in which a negative meniscus lens L12 having a convex surface facing the object side and a positive meniscus lens L13 having a convex surface facing the object side are joined together, a cemented negative lens in which a biconvex positive lens L14 and a biconcave negative lens L15 are joined together, a biconcave negative lens L16, a biconvex positive lens L17, a biconvex positive lens L18, and a cemented negative lens in which a biconcave negative lens L19 and a biconvex positive lens L110 are joined together, and the above lenses are arranged in order from the object side along the optical axis.

The second lens group G2 is formed from a negative meniscus lens L21 having a concave surface facing the object side and a biconvex positive lens L22, and the above lenses are arranged in order from the object side along the optical axis.

The third lens group G3 is formed from a biconcave negative lens L31 and a biconvex positive lens L32, and the above lenses are arranged in order from the object side along the optical axis. A lens surface of the negative lens L31 on the image surface side is an aspherical surface. Both lens surfaces of the positive lens L32 are aspherical surfaces.

The fourth lens group G4 is formed from a biconvex positive lens L41 and a biconcave negative lens L42, and the above lenses are arranged in order from the object side along the optical axis. The image surface I is arranged on the image side of the fourth lens group G4.

The following table 7 raises values of data of the optical system according to the seventh example.

TABLE 7
[General Data]

| | |
|---|---|
| f = 34.300 | FNO = 1.230 |
| ω = 32.684 | Y = 21.600 |
| TL = 157.455 | Bf = 11.455 |
| fA = 70.486 | fR = −192.806 |
| fF1 = 74.747 | fF2 = 247.083 |
| fSa = 70.486 | fSr = 72.472 |
| fe = −39.734 | |

[Lens Data]

| Surface | | | | |
|---|---|---|---|---|
| Number | R | D | nd | νd |
| 1 | 66.961 | 2.000 | 1.81600 | 46.59 |
| 2 | 32.457 | 11.809 | | |
| 3 | 128.665 | 1.800 | 1.59319 | 67.90 |
| 4 | 40.741 | 9.802 | 2.00069 | 25.46 |
| 5 | 215.641 | 0.200 | | |
| 6 | 110.947 | 7.041 | 1.81600 | 46.59 |
| 7 | −112.594 | 1.500 | 1.51680 | 64.14 |
| 8 | 28.007 | 12.084 | | |
| 9 | −40.962 | 8.018 | 1.73037 | 32.23 |
| 10 | 857.978 | 0.200 | | |
| 11 | 70.201 | 9.539 | 1.81600 | 46.59 |
| 12 | −61.720 | 0.200 | | |
| 13 | 54.810 | 7.279 | 1.59349 | 67.00 |
| 14 | −212.179 | 2.494 | | |
| 15 | −66.201 | 1.500 | 1.73037 | 32.23 |
| 16 | 27.501 | 13.807 | 1.59319 | 67.90 |
| 17 | −57.491 | 2.000 | | |
| 18 | ∞ | (D18) | | (Aperture |
| | | | | Stop S) |
| 19 | −41.015 | 1.300 | 1.56732 | 42.58 |
| 20 | −310.485 | 0.200 | | |
| 21 | 38.747 | 7.973 | 1.77250 | 49.62 |
| 22 | −146.553 | (D22) | | |
| 23 | −42.724 | 1.500 | 1.62004 | 36.40 |
| 24* | 60.145 | 0.200 | | |
| 25* | 58.069 | 3.682 | 1.85108 | 40.12 |
| 26* | −62.761 | (D26) | | |
| 27 | 154.307 | 8.500 | 1.94595 | 17.98 |
| 28 | −76.392 | 1.740 | | |
| 29 | −47.089 | 3.595 | 1.75520 | 27.57 |
| 30 | 85.433 | Bf | | |

[Aspherical Surface Data]
24th Surface
κ = 1.0000, A4 = −1.09574E−04, A6 = 3.34832E−07,
A8 = −5.81576E−10, A10 = 4.32381E−13
25th Surface
κ = 1.0000, A4 = −7.33927E−05, A6 = 3.59893E−07,
A8 = −6.97315E−10, A10 = 4.91900E−13
26th Surface
κ = 1.0000, A4 = 1.43166E−05, A6 = 1.17989E−07,
A8 = −2.22684E−10, A10 = 1.31507E−13

[Variable Distance Data]

| | Upon focusing | Upon focusing |
|---|---|---|
| | on infinity | on a short-distance |
| | f = 34.300 | β = −0.03333 |
| D0 | ∞ | 987.480 |
| D18 | 16.159 | 14.666 |
| D22 | 7.879 | 7.859 |
| D26 | 2.000 | 3.512 |
| Bf | 11.455 | 11.455 |

[Lens Group Data]

| | First | Focal |
|---|---|---|
| Group | surface | length |
| G1 | 1 | 70.486 |
| G2 | 19 | 74.747 |
| G3 | 23 | 247.083 |
| G4 | 27 | −192.806 |

FIG. 14(A) illustrates diagrams of various aberrations of the optical system according to the seventh example upon focusing on infinity. FIG. 14(B) illustrates diagrams of various aberrations of the optical system according to the seventh example upon focusing on a short distance object. Based on each of the diagrams of various aberrations, it may be understood that not only upon focusing on infinity but also focusing on a short distance object, the optical system according to the seventh example properly corrects various aberrations and exhibits excellent image formation performance.

### Eighth Example

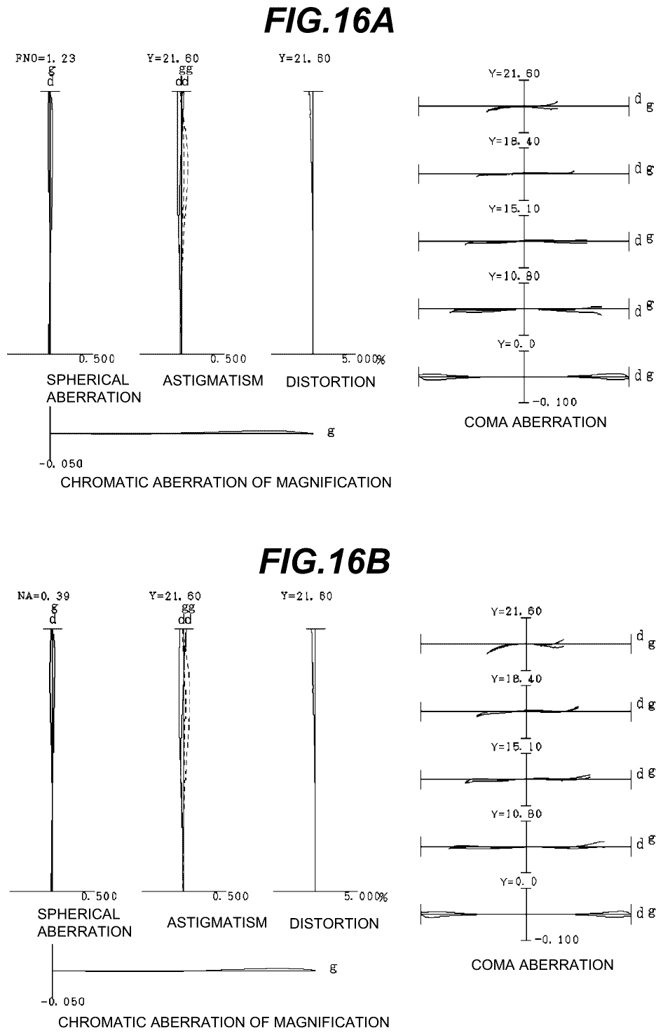

The eighth example will be described by using FIG. 15, FIG. 16, and the table 8. FIG. 15 is a diagram illustrating a lens configuration of the optical system according to the eighth example. The optical system OL(8) according to the eighth example is formed from a first lens group G1 having positive refractive power, a second lens group G2 having positive refractive power, a third lens group G3 having positive refractive power, and a fourth lens group G4 having negative refractive power, which are arranged in order from the object side along the optical axis. In focusing from an object at infinity to an object at a short distance, the second lens group G2 and the third lens group G3 move to the object side along the optical axis in different loci (different in movement amounts), and intervals between the neighboring lens groups are thereby changed. Note that in focusing, positions of the first lens group G1 and the fourth lens group G4 are fixed with respect to the image surface I.

The aperture stop S is disposed between the first lens group G1 and the second lens group G2. In focusing, a position of the aperture stop S is fixed with respect to the image surface I. In the present example, the first lens group G1 constitutes the front group GA, the second lens group G2 and the third lens group G3 constitute the intermediate group GM, and the fourth lens group G4 constitutes the rear group GR. Further, the second lens group G2 corresponds to the first focusing lens group GF1, and the third lens group G3 corresponds to the second focusing lens group GF2.

The first lens group G1 is formed from a negative meniscus lens L11 having a convex surface facing the object side, a negative meniscus lens L12 having a convex surface facing the object side, a cemented positive lens in which a positive meniscus lens L13 having a convex surface facing the object side and a negative meniscus lens L14 having a convex surface facing the object side are joined together, a cemented negative lens in which a biconcave negative lens L15 and a biconvex positive lens L16 are joined together, a biconvex positive lens L17, a biconvex positive lens L18, and a cemented negative lens in which a biconcave negative lens L19 and a biconvex positive lens L110 are joined together, and the above lenses are arranged in order from the object side along the optical axis. A lens surface of the negative meniscus lens L12 on the image surface side is an aspherical surface.

The second lens group G2 is formed from a biconcave negative lens L21 and a biconvex positive lens L22, and the above lenses are arranged in order from the object side along the optical axis.

The third lens group G3 is formed from a positive meniscus lens L31 having a convex surface facing the object side and a biconvex positive lens L32, and the above lenses are arranged in order from the object side along the optical axis. A lens surface of the positive meniscus lens L31 on the image surface side is an aspherical surface. A lens surface of the positive lens L32 on the image surface side is an aspherical surface.

The fourth lens group G4 is formed from a positive meniscus lens L41 having a concave surface facing the object side and a negative meniscus lens L42 having a concave surface facing the object side, and the above lenses are arranged in order from the object side along the optical axis. The image surface I is arranged on the image side of the fourth lens group G4.

The following table 8 raises values of data of the optical system according to the eighth example.

TABLE 8
[General Data]

| | |
|---|---|
| f = 35.000 | FNO = 1.230 |
| ω = 31.746 | Y = 21.600 |
| TL = 145.455 | Bf = 10.955 |
| fA = 55.625 | fR = −115.422 |
| fF1 = 489.379 | fF2 = 77.454 |
| fSa = 55.625 | fSr = 106.986 |
| fe = −55.441 | |

[Lens Data]

| Surface | | | | |
|---|---|---|---|---|
| Number | R | D | nd | νd |
| 1 | 67.860 | 2.000 | 1.48749 | 70.31 |
| 2 | 28.552 | 8.759 | | |
| 3 | 56.466 | 1.800 | 1.58887 | 61.13 |
| 4* | 37.716 | 3.790 | | |
| 5 | 51.569 | 7.504 | 2.00100 | 29.12 |
| 6 | 12706.656 | 1.500 | 1.49782 | 82.57 |
| 7 | 39.896 | 11.204 | | |
| 8 | −34.883 | 1.500 | 1.85451 | 25.15 |
| 9 | 63.438 | 8.797 | 1.56732 | 42.58 |
| 10 | −166.403 | 0.200 | | |
| 11 | 208.847 | 8.476 | 2.00069 | 25.46 |
| 12 | −55.223 | 0.200 | | |
| 13 | 42.842 | 9.992 | 1.59349 | 67.00 |
| 14 | −402.195 | 2.085 | | |
| 15 | −164.696 | 1.500 | 1.69895 | 30.13 |
| 16 | 27.200 | 14.211 | 1.59319 | 67.90 |
| 17 | −118.275 | 2.983 | | |
| 18 | ∞ | (D18) | | (Aperture |
| | | | | Stop S) |
| 19 | −41.627 | 1.300 | 1.68376 | 37.64 |
| 20 | 117.749 | 0.200 | | |
| 21 | 37.122 | 8.000 | 1.59349 | 67.00 |
| 22 | −76.861 | (D22) | | |
| 23 | 32.715 | 5.200 | 1.85108 | 40.12 |
| 24* | 46.365 | 4.147 | | |
| 25 | 212.737 | 2.500 | 1.77387 | 47.25 |
| 26* | −1000.777 | (D26) | | |
| 27 | −811.142 | 3.025 | 1.94595 | 17.98 |
| 28 | −93.510 | 2.770 | | |
| 29 | −37.711 | 1.500 | 1.73037 | 32.23 |
| 30 | −558.335 | Bf | | |

[Aspherical Surface Data]
4th Surface
κ = 1.0000, A4 = −1.76373E−06, A6 = −1.17943E−09,
A8 = −1.59414E−12, A10 = −1.08316E−15
24th Surface
κ = 1.0000, A4 = −3.14395E−06, A6 = −1.49476E−08,
A8 = −1.54681E−11, A10 = 1.13351E−13
26th Surface
κ = 1.0000, A4 = 1.94012E−05, A6 = 2.29617E−08,
A8 = 1.02524E−10, A10 = −2.34228E−13

[Variable Distance Data]

| | Upon focusing | Upon focusing |
|---|---|---|
| | on infinity | on a short-distance |
| | f = 35.000 | β = −0.03333 |
| D0 | ∞ | 1010.855 |
| D18 | 12.903 | 11.498 |
| D22 | 2.081 | 1.999 |
| D26 | 4.374 | 5.861 |
| Bf | 10.955 | 10.955 |

[Lens Group Data]

| | First | Focal |
|---|---|---|
| Group | surface | length |
| G1 | 1 | 55.625 |
| G2 | 19 | 489.379 |
| G3 | 23 | 77.454 |
| G4 | 27 | −115.422 |

FIG. 16(A) illustrates diagrams of various aberrations of the optical system according to the eighth example upon focusing on infinity. FIG. 16(B) illustrates diagrams of various aberrations of the optical system according to the eighth example upon focusing on a short distance object. Based on each of the diagrams of various aberrations, it may be understood that not only upon focusing on infinity but also focusing on a short distance object, the optical system according to the eighth example properly corrects various aberrations and exhibits excellent image formation performance.

Next, a table of [conditional expression corresponding values] will be illustrated in the following. This table indicates, in a summarized manner, values corresponding to the conditional expressions (1) to (11) for all of the examples (first to eighth examples).

$$0.01 < fF 2 / fF 1 < 10. \qquad Conditional Expression ( 1 )$$

$$0.5 < Y / Bf < 5. 00 \qquad Conditional Expression ( 2 )$$

$$0.05 < fSr / fSa < 4.00 \qquad Conditional Expression ( 3 )$$

$$0.05 < fF 2 / fA < 8. 00 \qquad Conditional Expression ( 4 )$$

$$0.1 < ( - fR ) / fF 2 < 8.00 \qquad Conditional Expression ( 5 )$$

$$0.02 < fA / fF 1 < 4. \qquad Conditional Expression ( 6 )$$

$$0.1 < fF 1 / ( - fR ) < 8.00 \qquad Conditional Expression ( 7 )$$

$$0.1 < fA / ( - fR ) < 4.00 \qquad Conditional Expression ( 8 )$$

$$1. < f / Bf < 8. 00 \qquad Conditional Expression ( 9 )$$

$$0.5 < TL / f < 7.00 \qquad Conditional Expression ( 10 )$$

$$0.1 < fe / fR < 0. 90 \qquad Conditional Expression ( 11 )$$

### [Conditional Expression Corresponding Value] (First to Fourth Example)

| Conditional | First | Second | Third | Fourth |
|---|---|---|---|---|
| Expression | example | example | example | example |
| (1) | 0.285 | 0.301 | 0.506 | 0.156 |
| (2) | 1.682 | 1.768 | 1.681 | 1.894 |
| (3) | 0.268 | 0.314 | 0.221 | 1.447 |
| (4) | 0.277 | 0.296 | 0.288 | 1.280 |
| (5) | 1.649 | 1.519 | 2.045 | 2.020 |
| (6) | 1.029 | 1.018 | 1.758 | 0.122 |
| (7) | 2.126 | 2.184 | 0.966 | 3.168 |
| (8) | 2.188 | 2.224 | 1.699 | 0.387 |
| (9) | 2.976 | 4.004 | 2.976 | 2.994 |
| (10) | 2.321 | 1.903 | 2.235 | 4.241 |
| (11) | 0.696 | 6.125 | 0.536 | 0.337 |

### [Conditional Expression Corresponding Value] (Fifth to Eighth Example)

| Conditional | Fifth | Sixth | Seventh | Eighth |
|---|---|---|---|---|
| Expression | example | example | example | example |
| (1) | 0.111 | 0.836 | 3.306 | 0.158 |
| (2) | 1.894 | 1.894 | 1.894 | 1.981 |
| (3) | 1.231 | 0.812 | 1.028 | 1.923 |
| (4) | 1.074 | 0.770 | 3.505 | 1.392 |
| (5) | 2.370 | 1.038 | 0.780 | 1.490 |
| (6) | 0.104 | 1.085 | 0.943 | 0.114 |
| (7) | 3.790 | 1.152 | 0.388 | 4.240 |
| (8) | 0.393 | 1.251 | 0.366 | 0.482 |
| (9) | 2.994 | 2.994 | 2.994 | 3.195 |
| (10) | 4.241 | 4.532 | 4.591 | 4.156 |
| (11) | 0.339 | 0.445 | 0.206 | 0.480 |

In each of the above examples, an optical system can be realized which has bright and favorable optical performance while having a small size.

Each of the above examples represents one specific example of the invention of the present application, and the invention of the present application is not limited to those.

It is possible to appropriately employ the following contents in a range in which optical performance of the optical systems of the present embodiment is not impaired.

Four-group configurations are described as the examples of the optical systems of the present embodiment; however, the present application is not limited to those, and optical systems in other group configurations (for example, five groups, six groups, seven groups and so forth) can be formed. Specifically, a configuration is possible in which a lens or a lens group is added to a position, which is closest to the object or closest to the image surface, in each of the optical systems of the present embodiment. A configuration is possible in which a lens or a lens group is added between the first focusing lens group and the second focusing lens group in the intermediate group in each of the optical systems of the present embodiment. Note that a lens group denotes a portion having at least one lens that is separated by an air distance which changes in focusing.

A lens group or a partial lens group is moved so as to have a component in a vertical direction to the optical axis or is rotationally moved (swung) in an in-plane direction including the optical axis, and a vibration-proof lens group may thereby be provided which corrects an image blur caused due to camera shake.

A lens surface may be formed with a spherical surface or a flat surface or may be formed with an aspherical surface. A case where the lens surface is a spherical surface or a flat surface is preferable because processing, assembly, and adjustment of a lens become easy and degradation of optical performance due to errors in processing, assembly, and adjustment can be prevented. Further, the above case is preferable because degradation of representation performance is small even in a case where the image surface is deviated.

In a case where the lens surface is an aspherical surface, the aspherical surface may be any of an aspherical surface by a grinding process, a glass-molding aspherical surface in which glass is formed into an aspherical shape by a mold, and a composite type aspherical surface in which a resin is formed into an aspherical shape on a surface of glass. Further, the lens surface may be formed as a diffraction surface, and a lens may be formed as a gradient-index lens (GRIN lens) or a plastic lens.

Although it is preferable that an aperture stop be arranged between the first lens group constituting the front group and the second lens group constituting the intermediate group, without providing a member as the aperture stop, its function may be provided by a frame of a lens instead. Further, the first focusing lens group may be arranged to be opposed to the image surface side of the aperture stop.

In order to reduce a flare or a ghost and to achieve optical performance with high contrast, each lens surface may be coated with an anti-reflection film which has a high transmittance in a wide wavelength range.

### EXPLANATION OF NUMERALS AND CHARACTERS

G1 first lens group
G2 second lens group
G3 third lens group
G4 fourth lens group
I image surface
S aperture stop

1. An optical system essentially consisting of:
a front group; an intermediate group; and a rear group, which are arranged in order from an object side along an optical axis, wherein
the intermediate group essentially consists of a first focusing lens group having positive refractive power and a second focusing lens group having positive refractive power, which are arranged in order from the object along the optical axis,
in focusing, the first focusing lens group and the second focusing lens group move along the optical axis differently with different loci from each other, and the front group and the rear group are fixed with respect to an image surface,
the rear group comprises a negative lens which is arranged at a position closest to an image surface in the rear lens group, and
the following conditional expressions are satisfied:
$$0.01 < fF2 / fF 1 < 10.$$
$$0.5 < Y / Bf < 5. 00$$
where
fF1: a focal length of the first focusing lens group,
fF2: a focal length of the second focusing lens group,
Y: an image height of the optical system, and
Bf: a back focal length of the optical system.

2. The optical system according to claim 1, wherein
an aperture stop is further provided, and
the following conditional expression is satisfied:
$$0. 05 < fSr / fSa < 4.00$$
where fSr: a combined focal length, upon focusing on infinity, of a lens, which is arranged on the image surface side relative to the aperture stop, in the optical system, and
fSa: a combined focal length, upon focusing on infinity, of a lens, which is arranged on the object side relative to the aperture stop, in the optical system.

3. The optical system according to claim 1 or 2, wherein
the following conditional expression is satisfied:
$$0. 05 < fF2 / fA < 8.00$$
where fA: a focal length of the front group.

4. The optical system according to any one of claims 1 to 3, wherein
the following conditional expression is satisfied:
$$0. 10 < ( - fR ) / fF 2 < 8.$$
where fR: a focal length of the rear group.

5. The optical system according to any one of claims 1 to 4, wherein
the following conditional expression is satisfied:
$$0. 02 < fA / fF 1 < 4.$$
where fA: a focal length of the front group.

6. The optical system according to any one of claims 1 to 5, wherein
the following conditional expression is satisfied:
$$0. 10 < fF 1 / ( - fR ) < 8.00$$
where fR: a focal length of the rear group.

7. The optical system according to any one of claims 1 to 6, wherein
the following conditional expression is satisfied:
$$0. 10 < fA / ( - fR ) < 4.00$$
where fR: a focal length of the rear group.

8. The optical system according to any one of claims 1 to 7, wherein
the following conditional expression is satisfied:
$$1. < f / Bf < 8.00$$
where f: a focal length of the optical system.

9. The optical system according to any one of claims 1 to 8, wherein
the following conditional expression is satisfied:
$$0.5 < TL / f < 7. 00$$
where f: a focal length of the optical system, and
TL: an entire length of the optical system.

10. The optical system according to any one of claims 1 to 9, wherein
the following conditional expression is satisfied:
$$0. 10 < fe / fR < 0.90$$
where fe: a focal length of a negative lens which is arranged in a position of the rear group which is closest to the image surface, and
fR: a focal length of the rear group.

11. The optical system according to any one of claims 1 to 10, further comprising
an aperture stop which is provided between the front group and the intermediate group.

12. The optical system according to any one of claims 1 to 11, wherein
the front group has positive refractive power.

13. The optical system according to any one of claims 1 to 12, wherein
the rear group has negative refractive power.

14. An optical apparatus comprising the optical system according to any one of claims 1 to 13.

15. A method for manufacturing an optical system, which essentially consists of: a front group; an intermediate group; and a rear group, which are arranged in order from an object side along an optical axis, comprising a step for arranging the lens groups in a lens barrel so that;
the intermediate group essentially consists of a first focusing lens group having positive refractive power and a second focusing lens group having positive refractive power, which are arranged in order from the object along the optical axis,
in focusing, the first focusing lens group and the second focusing lens group move along the optical axis differently with different loci from each other, and the front group and the rear group are fixed with respect to an image surface,
the rear group comprises a negative lens which is arranged at a position closest to an image surface in the rear lens group, and
the following conditional expressions are satisfied:
$$0.01 < fF 2 / fF 1 < 10.$$
$$0.5 < Y / Bf < 5. 00$$
where
fF1: a focal length of the first focusing lens group,
fF2: a focal length of the second focusing lens group,
Y: an image height of the optical system, and
Bf: a back focal length of the optical system.
